(19) United States
(12) Patent Application Publication
(10) Pub. No.: US 2021/0049641 A1
(43) Pub. Date: Feb. 18, 2021

(54) AFFILIATE-DRIVEN BENEFITS MATCHING SYSTEM AND METHODS WITH BENEFITS ALONG PLANNED ROUTE

(71) Applicant: UMB INTERNATIONAL, LLC, West Palm Beach, FL (US)

(72) Inventor: Bernard R. BAKER, III, West Palm Beach, FL (US)

(73) Assignee: UMB INTERNATIONAL, LLC, West Palm Beach, FL (US)

(21) Appl. No.: 17/087,215

(22) Filed: Nov. 2, 2020

Related U.S. Application Data
(63) Continuation of application No. 16/215,403, filed on Dec. 10, 2018.
Application No. 16/215,403 is a continuation-in-part of application No. 15/701,068, filed on Sep. 11, 2017, now abandoned.
Application No. 15/701,068 is a continuation-in-part of application No. 15/677,661, filed on Aug. 15, 2017, now abandoned.
Application No. 15/677,661 is a continuation-in-part of application No. 15/256,919, filed on Sep. 6, 2016, now abandoned.
Application No. 15/256,919 is a continuation of application No. 14/499,960, filed on Sep. 29, 2014, now abandoned.
Application No. 14/499,960 is a continuation of application No. 13/167,526, filed on Jun. 23, 2011, now abandoned.
(60) Provisional application No. 61/437,097, filed on Jan. 28, 2011.
(60) Provisional application No. 62/629,902, filed on Feb. 13, 2018.
(60) Provisional application No. 62/385,591, filed on Sep. 9, 2016.

(51) Int. Cl. G06Q 30/02; G06Q 50/00

(52) U.S. Cl. CPC G06Q 30/0255; G06Q 30/0253; G06Q 30/0248; G06Q 50/01; G06Q 30/0222; G06Q 30/0269; G06Q 30/0267; G06Q 30/0261; G06Q 30/0256

(57) ABSTRACT

Methods and systems for matching a consumer to benefits offered by enabling organizations provide flexibility and utility to consumers in the marketplace for various products. Information about benefits and enabling organizations are provided and stored in a memory of a computer system. A search query including consumer interest data of a consumer, or results of such a search query, are received. The enabling organization information, benefit information, and search query or information related to the search query results are analyzed automatically in the computer system to determine whether any enabling organization to which the consumer is affiliated is offering a benefit for the consumer that is applicable to the consumer interest data. Also determined may be one of: a display suppression window, whether benefits may be stacked together for use with a single purchase, and whether benefits are available at a venue within a predetermined distance of a planned route.

### CROSS-REFERENCE TO RELATED APPLICATIONS

This application is a continuation of U.S. application Ser. No. 16/215,403 filed 10 Dec. 2018 entitled “Affiliate-Driven Benefits Matching System and Methods with Benefits Along Planned Route”, which is a continuation-in-part of U.S. application Ser. No. 15/701,068 filed 11 Sep. 2017 entitled “Affiliate-Driven Benefits Matching System and Methods with Coupons, which in turn is a continuation-in-part of U.S. application Ser. No. 15/677,661 filed 15 Aug. 2017 entitled “Affiliate-Driven Benefits Matching System and Methods with Location-Triggered Benefit Alert and Search Score Determination” which in turn is a continuation-in-part of U.S. application Ser. No. 15/256,919 filed on 6 Sep. 2016 entitled “Affiliate-Driven Benefits Matching System and Methods” which in turn is a continuation of U.S. application Ser. No. 14/499,960 filed on 29 Sep. 2014 entitled “Affiliate-Driven Benefits Matching System and Methods” which in turn is a continuation of U.S. application Ser. No. 13/167,526 filed 23 Jun. 2011 entitled “Affiliate-Driven Benefits Matching System and Method” which claims priority under 35 U.S.C. § 119(e) from U.S. Provisional Application No. 61/437,097, filed 28 Jan. 2011. This application also claims priority under 35 U.S.C. § 119(e) from U.S. Provisional Application No. 62/629,902, filed 13 Feb. 2018. Additionally, U.S. application Ser. No. 15/701,068 claims priority under 35 U.S.C. § 119(e) from U.S. Provisional Application No. 62/385,591, filed 9 Sep. 2016. The entirety of each of the above applications is hereby incorporated herein by reference.

### BACKGROUND

In the modern marketplace, various types of relationships link individuals, organizations, and/or goods/service providers to one another. Individuals may seek goods or services from a goods/service provider that provides goods and/or services. For example, an individual may be interested in attending an event such as a basketball game that is provided by a basketball league or association. Organizations are often aware of such interests and may form relationships with goods/service providers that enable the organizations to provide benefits to their constituencies that are related to such interests. For example, a credit card issuer may offer tickets to a basketball game at a reduced rate or for free to its cardholders, possibly contingent on some condition such as a minimum charge threshold. Offering such a benefit may have the effect of rewarding existing cardholders and thus strengthening a relationship between the cardholders and the credit card issuer. New cardholders may also be enticed to form an affiliation with the credit card issuer, e.g., by signing up for one of its credit cards, based on the desirability of the benefits offered by the card issuer.

Consumers face certain challenges in such a marketplace. Consumers may be eligible for various benefits offered by various organizations but may not be able to access such information in a convenient way. For example, an individual may not even know of all the benefits to which she is entitled, or she may not know all the various websites she must visit in order to access information regarding benefits from various organizations. Even if she knows all her available benefits, she may not know of any restrictions on claiming the benefits or whether the benefits are even valuable. For example, a cardholder who is entitled to free basketball tickets might not be aware that the tickets are only valid for a particular game, that the tickets correspond to an undesirable seat location, or that the tickets must be picked up through a convoluted process. Also, she may not have the information available at the time when she is making the decision to purchase. With these and other drawbacks, individuals may under-utilize their available benefits or be disappointed in them, making the entire process of offering benefits less productive or efficient to consumers, organizations, and goods/service providers alike.

Additionally, it would be beneficial to the consumer, as well as to an establishment, if she were to be alerted to available benefits if she comes in proximity to an establishment offering benefits to which she is entitled. Such an alert would allow the consumer to take advantage of a benefit of which she may not be aware and would steer potential business to the establishment.

Furthermore, a filtering mechanism/procedure would be useful to the consumer so that the consumer, upon entering consumer interest data (which may include a search request based on particular parameters chosen by the consumer), is not inundated with low-quality results (e.g., results for a restaurant for dinner in a city 500 miles away from the consumer's location). Instead, the consumer would be presented with on ordered list of the most relevant results based on the search request.

Still further, it would be useful to the consumer to suggest which particular payment card (e.g., credit card, debit card, gift card, etc., and including an electronic payment system and/or method that is not card-based) a consumer may want to use for a particular purchase.

### SUMMARY

The increased use of “social media” and other electronic means of communication among consumers will make it possible for consumers to pool information about benefits in one place, thereby reducing or eliminating the above drawbacks. Additionally, members of an online community may communicate amongst themselves and/or with one or more enabling organizations about loyalty programs, available benefits, etc. As discussed herein, the present inventive embodiments overcome the above drawbacks to thereby increase the usefulness and efficiency of loyalty and/or benefit programs.

An embodiment is a computer-implemented method for matching a consumer to a benefit. The method may include receiving, from an affiliate of one of multiple enabling organizations, benefit information pertaining to at least one benefit the affiliate knows is offered by that enabling organization. An affiliate is an entity that has an affiliation with an enabling organization that renders the entity capable of receiving a benefit from the enabling organization. For example, an affiliate may be a member of an enabling organization, although affiliation is broader than membership (an affiliate need not be a member). The method may also include providing a software application to a consumer. Enabling organization information and consumer identification information may be received from the consumer via the software application. The enabling organization pertains to an enabling organization to which the consumer is affiliated. The consumer identification information identifies the consumer. In a memory of a computer system, the enabling organization information and benefit information may be stored. A search query including consumer interest data from the consumer may be received at a search engine. One or more query results may be generated with the search engine responsive to said search query. The enabling organization information, benefit information, and information related to the search query may be analyzed automatically in the computer system to determine whether any enabling organization to which the consumer is affiliated is offering a benefit for that consumer that is applicable to the consumer interest data. The query results may be displayed. Adjacent to the displayed query results, a message may be displayed to inform the consumer of an available benefit applicable to the consumer interest data.

An embodiment is a benefits matching system including one or more computer processors, a memory coupled to the processor(s), and a computer readable storage medium that has computer-executable instructions stored tangibly thereon. When executed, the instructions cause the processor(s) to perform various operations, including the following. Benefit information is received pertaining to at least one benefit that an affiliate of one of several enabling organizations knows is offered by that one enabling organization. Enabling organization information is received pertaining to an enabling organization to which a consumer is affiliated. In a memory of a computer system, the enabling organization information and the benefit information are stored. Search query results are received corresponding to a search query performed by the consumer. The search query includes consumer interest data. The enabling organization information, benefit information, and information related to the search query results are analyzed automatically in the computer system to provide analysis results, to determine whether any enabling organization to which the consumer is affiliated is offering a benefit for the consumer that is applicable to the consumer interest data. A message is sent including the analysis results based on the query results, to inform the consumer of an available benefit applicable to the consumer interest data.

An embodiment is a benefits matching system including one or more computer processors, a memory coupled to the processor(s), and a computer readable storage medium that has computer-executable instructions stored tangibly thereon. When executed, the instructions cause the processor(s) to perform various operations, including the following. Benefit information is received pertaining to at least one benefit that an affiliate of one of several enabling organizations knows is offered by that one enabling organization. Enabling organization information is received pertaining to an enabling organization to which a consumer is affiliated. In a memory of a computer system, the enabling organization information and the benefit information are stored. A search query including consumer interest data of the consumer is received. The enabling organization information, benefit information, and search query results are analyzed automatically in the computer system to provide analysis results, to determine whether any enabling organization to which the consumer is affiliated is offering a benefit for the consumer that is applicable to the consumer interest data. A message is sent including the analysis results based on the search query, to inform the consumer of an available benefit applicable to the consumer interest data.

An embodiment is a computer-implemented method for matching a consumer to available benefits. The method may include receiving, from a first affiliate (as a non-limiting example, a credit card holder) of an enabling organization (as a non-limiting example, a credit card issuer), benefit information pertaining to at least one benefit that the affiliate knows is offered by the enabling organization. The enabling organization may be one (or more) of multiple enabling organizations. From a consumer, enabling organization information may be received pertaining to an enabling organization with which the consumer is affiliated. Also, consumer information may be received from the consumer, including consumer identification information for identifying the consumer and consumer interest data for identifying at least one interest of the consumer (as a non-limiting example, an item the consumer wishes to purchase). In a memory of a computer system, the consumer information, enabling organization information, and benefit information may be stored. The consumer interest data, enabling organization information, and benefit information may be analyzed automatically in the computer system to determine whether any enabling organization to which the consumer is affiliated is offering a benefit for the consumer that is applicable to the consumer interest data. A message may be displayed to inform the consumer of an available benefit applicable to the consumer interest data.

An embodiment is a computer-implemented method for matching a consumer to available benefits. The method may include receiving, from a consumer, enabling organization information pertaining to an enabling organization (or multiple enabling organizations), among a plurality of enabling organizations, with which the consumer is affiliated and consumer information. The consumer information may include consumer identification information for identifying the consumer and consumer interest data for identifying at least one interest of the consumer. The method also includes providing benefit information pertaining to at least one benefit offered by one of the enabling organizations. In a memory of a computer system, the consumer information, enabling organization information, and benefit information may be stored. A rating and/or evaluation of one of the benefits offered by that one enabling organization may be received from an affiliate of that enabling organization different from the consumer. The consumer interest data, enabling organization information and benefit information may be analyzed automatically in the computer system to determine whether any enabling organization to which the consumer is affiliated is offering a benefit for said consumer that is applicable to the consumer interest data. A message may be displayed to inform the consumer of an available benefit applicable to the consumer interest data and may include the ratings and/or evaluations of the benefit provided by the other affiliates of the enabling organization.

An embodiment is a computer-implemented method for matching a consumer to available benefits. The method may include receiving, from a consumer, enabling organization information pertaining to an enabling organization (or multiple enabling organizations), among a plurality of enabling organizations, to which the consumer is affiliated and consumer information. The consumer information may include consumer identification information for identifying the consumer and consumer interest data for identifying at least one interest of the consumer. The method includes providing benefit information pertaining to at least one benefit offered by one of the enabling organizations. Benefit information may also be received from one or more enabling organizations. In a memory of a computer system, the consumer information, enabling organization information, and benefit information may be stored. The consumer interest data, enabling organization information, and benefit information may be analyzed automatically in the computer system to determine whether any enabling organization to which the consumer is affiliated is offering a benefit for the consumer that is applicable to the consumer interest data. In an event no benefit applicable to the consumer interest data is currently available, a message may be displayed to inform the consumer that he/she will be notified of a future benefit match. The consumer may be notified of a benefit applicable to the consumer interest data that subsequently becomes available.

An embodiment is a computer-implemented method for matching a consumer to available benefits. The method may include receiving, from an affiliate of one enabling organization, benefit information pertaining to at least one benefit that the affiliate knows is offered by the enabling organization. From a consumer, enabling organization information may be received pertaining to the enabling organization with which the consumer is affiliated. Also, consumer information may be received from the consumer, including consumer identification information for identifying the consumer and consumer interest data for identifying at least one interest of the consumer. In a memory of a computer system, the consumer information, enabling organization information, and benefit information may be stored. The consumer interest data, enabling organization information, and benefit information may be analyzed automatically in the computer system to determine whether the enabling organization is offering a benefit for the consumer that is applicable to the consumer interest data. A message may be displayed to inform the consumer of an available benefit applicable to the consumer interest data.

Some embodiments are benefits matching systems including one or more computer processors, a memory coupled to the processor(s), and a computer readable storage medium that has computer-executable instructions stored tangibly thereon. When executed, the instructions cause the processor(s) to perform the operations of the above-described computer-implemented methods for matching a consumer to available benefits.

Additional embodiments include the use of a Search Score Algorithm such that search results responsive to a search entered by a consumer (e.g., based on the consumer's consumer interest data) will be presented to the consumer in a list ordered such that the most relevant search results are displayed at the top of the list. Still further embodiments include the capability to notify a user that a previously-entered search query by the user has been met by a benefit added to the system after the query was entered.

Further embodiments include the use of an algorithm that takes into account information gleaned from a particular consumer's history, such as the types of venue the particular consumer typically searches, the frequency of those searches, either absolute or as a percentage of total searches, the price level of the venues typically searched, the rating of the venues typically chosen, etc. This consumer-specific information may be combined with geolocation information (of one or both of the consumer and a venue), the amount of time the consumer has spent at that particular venue, resulting in consumer benefit information being pushed out to the consumer for the particular venue without requiring the consumer to initiate a benefit search.

Further embodiments include aggregating coupons with other types of benefits available to a consumer from an enabling organization.

In still further embodiments, a consumer's payment card (e.g., credit card, debit card, gift card, etc., and including an electronic payment system and/or method that is not card-based) history may be used to form a decision as to which payment card the consumer should use for a particular purchase. The consumer's payment card history may take into account some (which may be selected fully or partly by the consumer and/or fully or partly selected by the system based on a particular algorithm) or all of the consumer's purchases over a certain date range. These date ranges can be any given date range and are not limited to contiguous or sequential days, e.g., the past week, the past month, the past year, the first week of every month over the past M number of months or the past Y number of years, the same month over the past Y years, the second quarter of each of the past Y years, a time span leading up to, covering, or after an event (e.g., a birthday, anniversary, tax payment due dates, etc.), or any other set of days/weeks/months/years that may be specific to a spending habit of the consumer. Alternatively, or in addition, to the above, the consumer's payment card history may be based on the consumer's particular type of purchases (e.g., restaurant meals, the type of restaurant, automobiles, home improvement items, a corporate or business purchase, flowers, clothes, shoes, purchases in a particular city/town/state/country, purchases from a particular website, etc.) Also, the consumer's particular type of purchases may be combined with other embodiments discussed herein (e.g., GPS information, coupon availability, venue algorithm, etc.) Where necessary, the consumer's permission to access the consumer's payment card history will be obtained/requested.

In other embodiments, the consumer receives a suggestion as to which particular payment card (e.g., credit card, debit card, gift card, etc., and including an electronic payment system and/or method that is not card-based) the consumer may want to use for a particular purchase. This suggestion may be based on consumer input, partially based on consumer input, or determined automatically without any consumer input.

In still other embodiments, a computer-implemented system and/or method for matching a consumer to one or more available benefits may automatically inform a consumer of an available benefit. However, constant or repetitive reminders may become an irritant to the consumer. Therefore, the computer-implemented system and/or method may include a suppression time window such that, if selected, the consumer will not be reminded/informed of a particular benefit more than a selectable number of times in the suppression time window. The suppression time window will have a selectable time duration that the consumer can change at his/her convenience.

In yet further embodiments, a computer-implemented system and/or method for matching a consumer to multiple available benefits may automatically inform a consumer that two or more of the multiple available benefits can be used simultaneously (e.g., the benefits can be stacked) for a single purchase.

In still further embodiments, a computer-implemented system and/or method for matching a consumer to one or more available benefits may be used in conjunction with input from a second, different, application and/or system, such as route information from a ride planning application/system, to provide notification to the consumer of available benefits along or at the terminus of the planned route. The benefit information may be pushed out to the consumer for viewing on a display that is connected to either the benefits system or the ride planning system.

### BRIEF DESCRIPTION OF THE DRAWINGS

The following will be apparent from elements of the figures, which are provided for illustrative purposes and are not necessarily to scale.

FIG. 1A is a block diagram in accordance with some embodiments.

FIG. 1B is a block diagram of an integrated system combining benefit matching functionality with search engine functionality in accordance with some embodiments.

FIG. 2 is a block diagram of a computer system in accordance with some embodiments.

FIG. 3 is a flow diagram in accordance with some embodiments.

FIG. 4 is a flow diagram in accordance with some embodiments.

FIG. 5 is a flow diagram in accordance with some embodiments.

FIG. 6 is a flow diagram in accordance with some embodiments.

FIG. 7 is a flow diagram in accordance with some embodiments.

FIG. 8 is a depiction of an example screenshot of a browser in accordance with some embodiments.

FIG. 9 is a depiction of an example screenshot of a browser in accordance with some embodiments.

FIG. 10 is a flow diagram in accordance with some embodiments.

FIG. 11 is a flow diagram in accordance with some embodiments which includes sorting a plurality of venues applicable to consumer interest data.

FIG. 12 is a flow diagram in accordance with some embodiments which includes comparing a consumer's geolocation with a geolocation of a venue.

FIG. 13 is a flow diagram in accordance with some embodiments which includes aggregating a coupon with an available benefit.

FIG. 14 is a flow diagram in accordance with some embodiments which includes aggregating a coupon with an available benefit.

FIG. 15 is a flow diagram in accordance with some embodiments which includes a payment card recommendation based on a consumer's purchase history.

FIG. 16 is a flow diagram in accordance with some other embodiments which includes a payment card recommendation based on a consumer's purchase history.

FIG. 17 is a flow diagram in accordance with some embodiments which includes determining a display suppression window.

FIG. 18 is a flow diagram in accordance with some embodiments which includes determining a notification count.

FIG. 19 is a flow diagram in accordance with some embodiments which includes determining stacked benefits.

FIG. 20 is a flow diagram in accordance with some embodiments which includes determining benefits available along a planned route.

### DETAILED DESCRIPTION

This description of the exemplary embodiments is intended to be read in connection with the accompanying drawings, which are to be considered part of the entire written description.

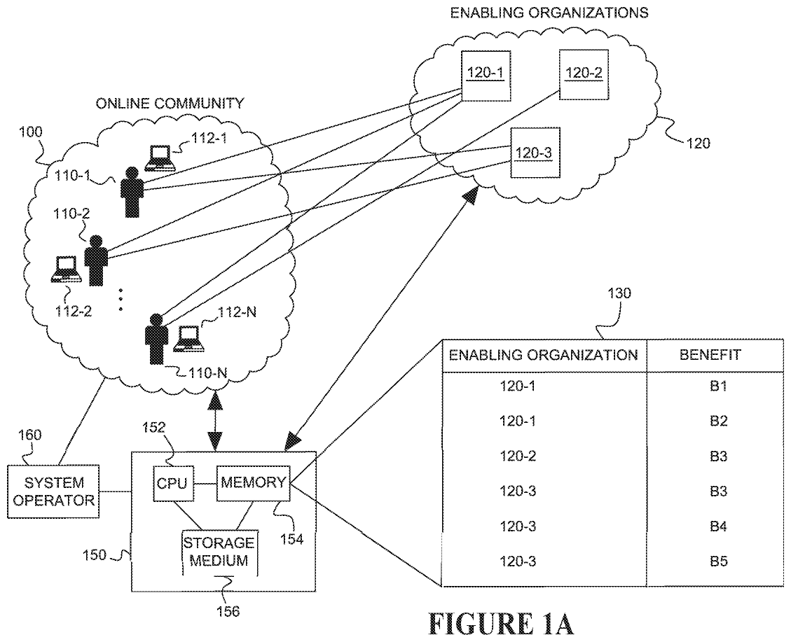

Referring to FIG. 1A, an online community 100 includes users 110-1, . . . , 110-N (collectively 110) who are interested in utilizing benefits offered by benefit-enabling organizations (“enabling organizations” for short) 120. Users in online community 100 are also interested in providing information about such benefits to other users. Due to network effects, the more users 110 there are who provide information about benefits to other users, the better off the entire community 100 will be in terms of awareness and utilization of benefits.

In this example, enabling organizations 120-1, 120-2, and 120-3 are shown, although any number of enabling organizations, including a single enabling organization, may be present. User 110-1 is affiliated with (is an affiliate of) organizations 120-1 and 120-3, user 110-2 is affiliated with organizations 120-1 and 120-3, and user 110-N is affiliated with organizations 120-1 and 120-2. Alternatively, in another embodiment, the user may not be affiliated with any of the enabling organizations and may be gathering information which may be used in deciding to become affiliated with one or more enabling organizations. Each enabling organization provides (offers) one or more benefits to its affiliates.

Benefits

As used herein, the term “benefits” may refer to, for example, any discounted rate or any other added value (including but not limited to full value for a good or service) received by a consumer in addition to those otherwise offered to the general public. A benefit may be, for example, a discount or some other deal on a particular good or service (e.g., flowers from a particular florist, or any other product or service from a goods/service provider) that is available to a user because of her affiliation with an enabling organization (e.g., because she has a particular credit card). Benefits may include points, miles (e.g., airline miles), or upgrades (e.g., from coach to first class air tickets) that may be accrued for redemption in accordance with various commonplace rewards programs. Benefits may also include cash. Some embodiments particularly facilitate the use of benefits which are offered to those consumers having an affiliation with one or more enabling organizations, which may be third party enabling organizations that are distinct from the consumer and from the goods/services provider.

Affiliation/Affiliate

An “affiliation” as used herein may refer to, for example, an association or relationship that an entity (e.g., an individual, although not limited to individuals) has with an enabling organization that renders the entity capable of receiving a benefit from the enabling organization. An affiliate is an entity that has an affiliation with an enabling organization. Membership in the enabling organization may be such an association, although affiliation is broader than membership (e.g., an entity need not be a member to be an affiliate). Some embodiments allow consumers who are affiliates of third party enabling organizations to make advantageous use of such benefits offered through such enabling organizations by correlating the specific benefits offered with the needs of the consumer, e.g., when she desires to purchase a product.

Enabling Organization

Enabling organizations may be any type of organization that provides, as a service to its affiliates, benefits related to goods or services. Such goods or services themselves may be provided by another organization or by the enabling organization. Examples of enabling organizations may include credit card issuers, frequently flyer programs, automobile or motorists' associations, public television stations, organizations directed to a particular demographic (e.g., retired or elderly people), etc. Enabling organizations are sometimes referred to as affinity groups. Additionally, enabling organizations may be entities whose business or purpose is to offer benefits or coupons (e.g., groupon.com, eatoutpaylessonline.com, mypoints.com, etc.).

Individuals (or other entities such as companies) may be affiliates of numerous enabling organizations, which may sometimes create administrative challenges related to keeping track of available benefits. In some embodiments, using the power of online communities, a user may efficiently identify which of her enabling organizations, if any, provide a benefit related to a product she is interested in, based on inputs from other affiliate(s). For example, referring to FIG. 1A, user 110-1 is affiliated with enabling organization 120-1, which offers benefits B1 and B2 to its affiliates. Enabling organizations may offer different sets of benefits to different affiliates, e.g., in a tiered affiliation/benefit paradigm. For the sake of illustration, assume that enabling organizations offer benefits to all of their respective affiliates as shown in table 130, which may be stored in a database, e.g., in a memory 154 of a computer system 150 (sometimes referred to as a “benefits matching system” herein). In this example, enabling organization offers benefits B1 and B2, enabling organization 120-2 offers benefit B3, and enabling organization 120-3 offers benefits B3, B4, and B5. As shown in this example, a given enabling organization may offer multiple benefits, and a given benefit may be offered by multiple enabling organizations.

In some embodiments, users 110 may access and manipulate data pertaining to enabling organizations and/or benefits through a web-based interface. For example, users 110 may visit a predetermined web site on the Internet (e.g., a portal) to participate in online community 100. Various known forms of authentication may be used to verify that a user is entitled to access such information pertaining to the online community.

User 110-1 may be aware of benefit B1 offered by enabling organization 120-1, e.g., because she has previously used that benefit or because she has learned of it in some manner. In some embodiments, user 110-1 may make this benefit information (e.g., the fact that a particular benefit is offered by a particular organization) known to the entire online community 100 by uploading the benefit information to system 150, e.g., using a computer terminal 112-1. Such uploaded benefit information is then available to other members of online community 100. System 150 may include a computer processor 152, a memory 154, and a computer readable storage medium 156. The uploaded benefit information may be stored in memory 154 at least until any applicable benefit expiration date(s). Computer terminal 112-1 may be a mobile device, e.g., a handheld computing platform such as a smart phone, or any suitable computing device. A handheld mobile device offers portability and convenience so that users may access functionality related to online community 100 from anywhere. For example, users may learn of benefits, upload information regarding benefits, or be matched to benefits from anywhere, and functionality related to geolocation and proximity detection as described below facilitates the utilization of benefits. As various users 110 populate the system 150 with information regarding various benefits, the entire community 100 enjoys greater awareness of such benefits through network effects.

By enabling affiliates of enabling organizations to directly provide benefit information to system 150, direct involvement with the enabling organizations 120 is not needed in some embodiments. Securing the cooperation and participation of enabling organizations is generally a resource-intensive problem that conventionally requires contacting and negotiating, and/or contracting with each of several enabling organizations. If any enabling organization “holds out,” benefit information related to that organization may be difficult to access in conventional systems. In contrast, harnessing the benefit information provided directly by affiliates as in various embodiments is simple, fast, cost-effective, and efficient in terms of removing a bottleneck from the information aggregation and utilization process.

In some embodiments, affiliates may rate and/or evaluate benefits, e.g., so that other affiliates may be in a better position to determine the viability or applicability of the benefits. For example, suppose user 110-1 has availed herself of benefit B1 (e.g., a discount on daffodils) offered by enabling organization 120-1 (e.g., a local florist). User 110-1 might have had a positive experience that she wishes to share with the online community 100 (e.g., the flowers were especially fresh and the service was prompt, or the discounted price was favorable and delivery was free, etc.). Alternatively, she might have had a negative experience (e.g., flowers were delivered late, or the discount only applied to certain flowers, etc.) or a neutral experience. She might have some information regarding her experience with the benefit that might be useful to others (e.g., the discount only applies to three-day-old flowers, or the discount only applies with the purchase of other flowers worth at least $50). In some embodiments, user 110-1 may provide a rating that captures such information. The rating may be qualitative (e.g., comments in the form of text), quantitative (e.g., a numerical score such as 3 out of 5 stars), or a combination of qualitative and quantitative feedback.

The rating for a particular benefit may be supplied by the same user who initially uploaded the benefit information pertaining to that benefit, or the rating may be supplied by a different user. For example, user 110-1 may upload benefit information for benefit B1 because she is aware of that benefit, but she might not supply a rating, e.g., because she has not used the benefit personally, because she has not formed an opinion of that benefit, because she does not wish to share her opinion, or for some other reason. User 110-2, who has also availed herself of benefit B1, may see that another user (in this case user 110-1) has provided information about benefit B1, and user 110-2 may supply a rating herself. In some embodiments, multiple users may supply a rating for the same benefit (e.g., users 110-1 and 110-2 both rate benefit B1), and the ratings from different users may be aggregated and/or combined (e.g., listed serially, averaged or combined via any other summary statistic).

In some embodiments, enabling organizations 120 may directly provide benefit information pertaining to the benefits that they offer, but only affiliates themselves (e.g., users 110) may rate the benefits. In this manner, users may have increased trust in the ratings and in the reliability of the benefits, as such information is provided directly by other users of the online community 100 rather than being provided by an enabling organization that has a vested interest in the matter. In some embodiments, information (e.g., benefit information or auxiliary information related to benefits) that is uploaded by an enabling organization is processed and/or displayed differently (e.g., with a different color or font, or in a different part of the screen) than information that is uploaded by an affiliate. By displaying benefit information received from affiliates and enabling organizations in different formats, users may perceive the source of such information, which may factor into their decision making processes.

In some embodiments, an affiliate of an enabling organization who provides a rating for a benefit may revise that rating. Additionally, some embodiments may include methods of detecting cheating on ratings and excluding or handicapping those ratings considered (or determined) to be falsified, suspicious, non-authentic, or lacking veracity. Handicapping may include giving less weight to certain ratings. One method of detecting cheating may include checking an identifying attribute (e.g., e-mail address or IP address) of an affiliate (or computer thereof) who provided multiple ratings in order to prevent “ballot box stuffing.” For example, reception of multiple ratings for a given benefit from the same email address (or the same IP address) may be a sign of cheating. Another method may include comparing the e-mail address or IP address of the affiliate who provided a rating regarding a benefit provided by a particular enabling organization with the e-mail address (e.g., domain) or IP address of that enabling organization to determine if there is a match. For example, a particular benefit may be offered by an enabling organization called XYZ. A rating that is received from an individual having email address joe@xyz.com may be regarded as suspect and a candidate for handicapping and/or exclusion, as that individual is likely an insider at the enabling organization. By “insider” is meant an employee or agent of an enabling organization, or some other person having a status with respect to the enabling organization that precludes that person from providing information regarding the enabling organization or its benefits in an unbiased, independent manner. Similarly, IP addresses may be compared to detect that a rating of a benefit offered by an enabling organization was provided from a computer located within that enabling organization's computer network. Thus, embodiments may detect the situation in which an individual poses as an affiliate of an enabling organization (who would presumably provide an independent and unbiased rating) but is actually the enabling organization's system administrator (for example) who has established a “front” for the enabling organization within the online community.

In some embodiments, various parties may provide information that facilitates the use of benefits. For example, in addition to uploading to system 150 the fact that enabling organization 120-1 offers benefit B1, user 110-1 may upload auxiliary information that is different from the mere existence of the benefit and that helps others use the benefit. Such auxiliary information may include a link (e.g., web hyperlink) to a web site of a service provider where the benefit may be obtained or redeemed, contact information relevant to acquiring or using the benefit, an expiration date of the benefit, or any other information that may be helpful to other users regarding the benefit. Such auxiliary information may be provided by a different user (e.g., user 110-2 in the example above) than the user who provided the basic benefit information, or it may be provided by an enabling organization or a system operator. In some embodiments, auxiliary information may be provided by affiliates but not by enabling organizations, in order to promote trust in such information on the part of users. A system operator 160 may be an individual who moderates or oversees the online community 100 and fills in helpful information. The system operator 160 may also provide benefits information to the system. In some embodiments, a system operator 160 may be an automated agent (e.g., a “bot”) that detects benefit information provided by users 110 and automatically processes and supplies auxiliary information, e.g., through automated searches or database lookups.

User 110-N, who is an affiliate of enabling organization 120-1 and thus qualifies for benefit B1, may see (e.g., via her computer terminal 112-N that interfaces with system 150) that enabling organization 120-1 offers benefit B1, because that information has been previously supplied. User 110-N may also see auxiliary information and/or ratings related to benefit B1. User 110-N may also see information pertaining to other benefits (e.g., benefit B2) offered by enabling organization 120-1 as well as benefits offered by enabling organization 120-2.

In addition to accessing such “static” content related to various benefits and enabling organizations, user 110-N (or any other user) may also receive “dynamic” content tailored to her individual interests and/or needs in some embodiments. For example, user 110-N, who may be termed a consumer in this context, may be automatically matched by computer system 150 to pertinent information spanning various benefit organizations and/or service providers, sparing her the trouble of having to check each enabling organization of which she is an affiliate in turn for possible benefits. User 110-N may provide enabling organization information pertaining to one or more enabling organizations to which she is affiliated (e.g., enabling organizations 120-1 and 120-2 in the example of FIG. 1A). User 110-N may also provide consumer information, including consumer identification information for identifying her (e.g., a user ID, name, or other identifier) and consumer interest data for identifying at least one of her interests. Consumer interest data may include general topics such as hiking, more tailored interests such as attending the opera in New York City on Saturday evenings, and/or specific information related to intended or desired purchases, such as an imminent purchase like a pair of shoes or a desire for travel in the more distant future using an airline ticket from Boston to Las Vegas during the first week of November.

The consumer information, enabling organization information, and benefit information may be stored in memory 154. The benefit information may have been provided by a different user than the user corresponding to the consumer information and enabling organization information. The consumer interest data, enabling organization information, and benefit information may be analyzed automatically in computer system 150 to determine whether any enabling organization to which user 110-N is affiliated is offering a benefit for her that is applicable to her consumer interest data. Automatic matches of such data may be effectuated by various computing techniques, as is known in the art of databases and search algorithms. For example, stored benefit information may be coded or represented in ways that enable searching at various levels of granularity. Thus, a given benefit such as “25% off any order of daffodils this Sunday” may be represented in system 150 in various categories that facilitate ease of querying, such as “daffodils,” “flowers,” “this Sunday,” “this weekend,” “discount,” etc. A user may search at any desired level of granularity (e.g., using various search terms in the example above) as she desires. Thus, the system 150 may hide from the user the underlying complexity of the particular database/query implementation used.

A message may be displayed to inform user 110-N of an available benefit (or benefits) applicable to her consumer interest data. The message may be in various forms, including but not limited to an icon, a pop-up window, displayed text, or any other visually perceptible format. The term “available” does not require benefit(s) to be active at the present time but also encompasses benefits that will become active in the future. The message informing the user of available benefit(s) may be displayed on computer terminal 112-N associated with user 110-N. The available benefit information may be provided and/or displayed to the user based on temporal and/or spatial factors. For example, the user may be informed of benefits that are available within a particular distance from her or from any specified location, or closest to her current location or any specified location. A list of nearest benefit matches may be sorted and presented to the user for increased convenience. The user may be apprised of available benefits based on timing considerations. For example, she may be informed of benefits that are currently active, that will be active soon (e.g., a deal that will be available the upcoming weekend) or that are only valid for a predetermined time period. Available benefits may be sorted based on timing, so that benefits that are active currently are displayed before benefits that will become active in the future, for example.

If multiple available benefits are applicable to the user's consumer interest data, some embodiments may display the available benefits in an order corresponding to a ranking of the benefits. The benefits may be ranked according to ratings, e.g., by displaying an available benefit having a higher rating before an available benefit having a lower rating. In some embodiments, a benefit having any rating may be ranked higher than (and be displayed before) a benefit having no rating. Benefits may also be ranked and displayed according to a predetermined quantitative metric related to the benefits. For example, if a user is entitled to a particular benefit (e.g., 10% discount on a particular desired product) based on her affiliation with a first enabling organization and a numerically (or in another way determinable) superior benefit (e.g., 20% discount on the product) based on her affiliation with a second enabling organization, the better benefit may be displayed first. In some embodiments, the predetermined metric may pertain to an absolute amount (e.g., cash back amount such as $10 off a good or service) rather than a relative (percentage) amount discounted.

In some embodiments, the user may be notified of a first benefit that is available through a first enabling organization to which she is affiliated, and she may also be notified of a second benefit that would be available to her if she were to become affiliated to a second enabling organization to which she is not currently affiliated. A message may be displayed to inform the user about the second enabling organization or about any benefit offered by that enabling organization. For example, user 110-1 who is first notified of a benefit (e.g., 10% discount) on tennis rackets available through enabling organization 120-1 to which she is affiliated may also be notified of a benefit (e.g., buy one, get one free) on tennis balls (or other tennis-related equipment) that would be available to her if she were to become affiliated with enabling organization 120-2. In some embodiments, in order to avoid flooding the user with information she may not want, information about enabling organizations to which the use is not currently affiliated, or information pertaining to benefits offered by such enabling organizations, is restricted or filtered based on proximity or similarity to the originally sought benefit. For example, a query for benefits related to tennis rackets may allow the user to learn of benefits on tennis rackets offered by enabling organizations to which she is currently affiliated as well as those to which she is not affiliated. Tennis rackets and tennis balls may be classified (automatically or manually) in a single category by the system, so that queries that result in notifications of benefits offered by enabling organization 120-1 regarding tennis rackets also may result in notifications of benefits offered by enabling organization 120-2 regarding tennis balls.

In some embodiments, a message may be displayed to invite the user to become affiliated with the other enabling organization to which she is not currently affiliated (enabling organization 120-2 in the example above). The user may provide an input indicating her desire to become affiliated, and the system may affiliate the user with that enabling organization. In some embodiments, if the user indicates a desire to become affiliated with an enabling organization, the system sends a message to that enabling organization indicating the user's desire. In other words, the system may act as a referral intermediary, in return for which referral the enabling organization may provide compensation. Thus, the system may directly form a new affiliation between the user and the new enabling organization or may serve as an intermediary in the affiliation process. In some embodiments, the system refers the user (e.g., directs the a web browser on the user's computer) to the new enabling organization's website.

Thus, a user (who may be regarded as a consumer in the context of desiring to purchase or use a good or service, or avail herself of a benefit related to a good or service) desiring to use her benefits (but not necessarily knowing the precise nature of her benefits, or which enabling organizations provide particular benefits) may input her consumer interest data (e.g., purchase plans, item she wishes to purchase, service she wishes to use, etc.). The system determines whether any enabling organization with which the user is affiliated provides benefits related to her consumer interest data and informs her of such benefit(s). Consumer interest data may encompass plans to purchase a good or service imminently or at any point in the future.

The user may decide whether to use such identified benefit(s) and may use the system for that purpose, e.g., by clicking on a link or contacting an enabling organization that is displayed. The system may receive an input from the user indicative of her desire to avail herself of such available benefit. For example, the user may click a button (or otherwise indicate to the system) that she wishes to book a ticket using mileage benefits, purchase flowers at a discount, etc. The system may purchase the good or service associated with said consumer interest data, or otherwise use the identified available benefit(s) (e.g., by notifying an airline or travel provider that a flight is to be booked using rewards miles) to execute the available benefit(s) for the user. Alternatively, the system may reserve such a transaction for a future time.

Such a purchase, reservation of a transaction, or execution of a benefit may also be performed in the context of a benefit that would be available if the user were to become affiliated with a new enabling organization (to which she is not currently affiliated). For example, the system may form or initiate the affiliation between the user and a new enabling organization and execute a benefit offered by that new enabling organization, saving the user time and effort.

Thus, in some embodiments, the user may directly access or use such identified benefits without having to take the intermediate step of contacting or visiting the website of an enabling organization providing such benefits. Eliminating this intermediate step may facilitate the user's use of benefits and make it more likely that benefits will actually get used.

If no benefits currently fit the user's purchase plans, the system may store the purchase plan information and notify the user if and when such a benefit becomes available (i.e., “push” the benefits information to the user, e.g., via email or text message). In order to avoid information overload, the user may request that only certain types of benefit information (e.g., benefits pertaining to museums, theater, dining, etc., in New York City) be pushed.

The system 150 may be accessed by mobile devices (e.g., by a mobile application running on a smart phone) or any other type of computer (e.g., desktop or notebook computers). Functionality related to mobile devices may include geolocation facilities (e.g., GPS functionality to determine the user's location and display nearby goods/service providers). For example, a user may simply enter that she wishes to purchase flowers within the next twenty-four hours, and the system 150 may determine whether any applicable benefits (e.g., discounts on flowers offered by an enabling organization to which the user is affiliated) are available within that time period. The user may then view such available benefits (e.g., benefits available in her vicinity or in some specified area) as well as any available ratings or auxiliary information related to the benefits, and she may then conveniently purchase flowers without the conventional difficulties associated with handling such benefits in the marketplace.

In some embodiments, benefit matching functionality may be integrated with search engine functionality to streamline the user experience. Modern computing technology offers various facilities for users to locate relevant information via search engines. Such search engines typically accept user input in the form of a text string, comprising a search query, and identify relevant search results (“hits”) matched to the query. Some embodiments of the present disclosure expand the scope and utility of search engines by providing information about relevant available benefits, as described above, in addition to traditional query results.

FIG. 1B is block diagram of an integrated system combining benefit matching functionality with search engine functionality. A user 110-i in online community 100 may access integrated benefit matching and search engine functionality via her computer terminal 112-i. Search capabilities of a search engine may be accessed in various ways. For example, user 110-i may enter a search query via a browser (e.g., web browser) 114 application on terminal 112-i. The browser may send the search query to a search engine 180 via a network 170 in various manners, e.g., using Hypertext Transfer Protocol (HTTP). Search engine 180 may process the search request and return search query results to browser 114. Upon installation of a browser tool application 116, browser 114 is enhanced to enable parsing of the received query results and formatting for transmission to benefit matching system 150.

Search engine 180 may be a public search engine accessible via the Internet, or it may be a search engine that is provided to limited members, e.g., to members of an organization, in which case network 170 may be a local area network (LAN). Alternatively, some embodiments of the present disclosure may provide a search engine 182 locally within computer 112-i. Regardless of whether the search engine is local or remote relative to computer 112-i, the user's experience is streamlined through integrated search and benefit matching capabilities.

Application 116 may be downloaded to terminal 112-i via the Internet or may be provided via a physical computer readable storage medium (e.g., CD-ROM). Application 116 may provide an add-on (e.g., plug-in) to browser 114, which may be one of various types of browsers. User 110-i may enter registration information using application 116, or using browser 114. User 110-i may specify one or more enabling organizations to which she is affiliated during registration, or she may have already entered her relevant information prior to registration. Authentication using any suitable technique may be performed at this stage to verify that the user does indeed have such affiliations. For example, the user may provide a user ID and password to establish her authenticity.

When user 110-i accesses search engine 180 as described above, information regarding benefits offered by enabling organizations is provided automatically to the user, without requiring the user to perform a benefit-centric search separately. For example, the user may perform a search query, for which query results are returned to browser 114. The query results may be sent to benefit matching system 150, which may check if any enabling organization to which user 110-i is affiliated is offering a benefit related to any query result or to the search query. The query results may be processed by system 150, which may provide user 110-i with relatively fine-grained information (e.g., regarding particular vendors). For example, a search for “Statue of Liberty” may produce search hits for particular vendors offering merchandise related to the Statue of Liberty. Those search hits may form an input to system 150 to identify available benefits. Alternatively, the search query may be diverted to system 150 before that query is processed by search engine 180. Determining available benefits based on the search query rather than search results may provide relatively coarse-grained information (e.g., regarding a particular topic rather than regarding individual vendors of services related to the topic). In this way, browser 114 may provide an intuitive front-end or interface to benefit matching system 150, so that the user can simply visit the website of a search engine to access benefit matching functionality.

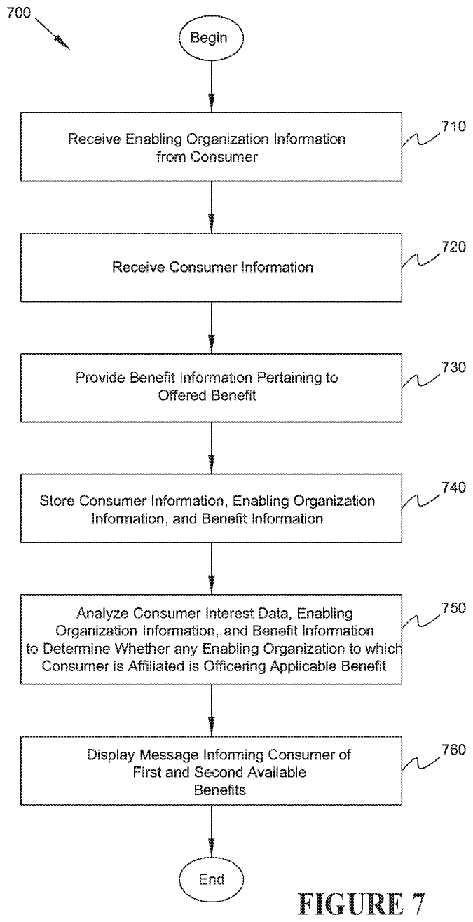

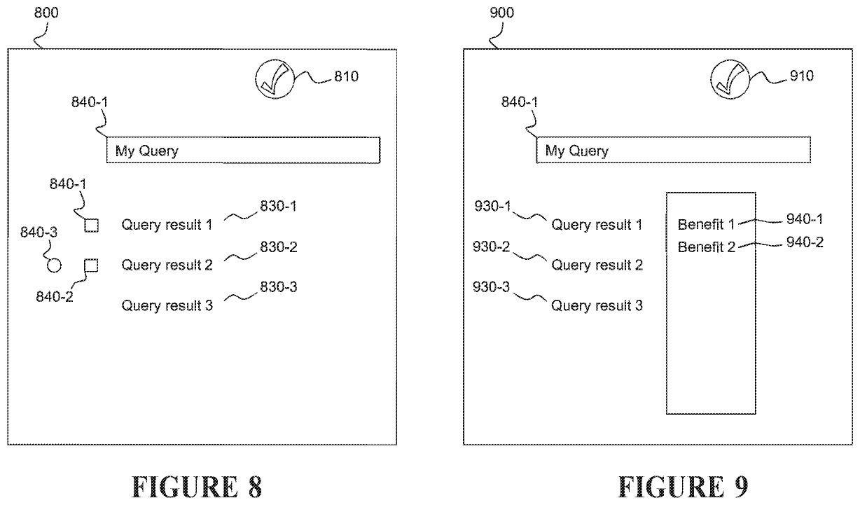

Thus, user 110-i may receive, in addition to conventional search results from the search engine, benefit-related information enabled by system 150 (e.g., information on benefits such as discounted tours of the Statue of Liberty made possible by the user's affiliation with an enabling organization). Such benefit-related information may be presented using icons adjacent to conventionally displayed search results to indicate that a benefit is available as in FIG. 8, or in a sidebar display in a format similar to advertisements as in FIG. 9.

In FIG. 8, a browser window 800 may include an icon 810 indicating whether the user is logged in to system 150 so that she may receive information about available benefits in addition to traditional search results. The user may enter a search query 820 using any of various input prompting mechanisms (e.g., a text box as shown in FIG. 8). Query results 830-1, 830-2, 830-3 returned by search engine 180 may be listed as shown. Next to each query result, one or more icons may be provided to indicate whether any enabling organization to which the user is affiliated is offering a benefit related to that query result or to the search query generally. FIG. 8 shows an example in which an icon 840-1 is displayed next to query result 830-1, and icons 840-2 and 840-3 are displayed next to query result 830-2. Icons may be displayed in a similar style or format, e.g., using the same shape (such as square icons) or color, to indicate benefits provided by a common enabling organization. Thus, each enabling organization may have a distinctive icon to identify its offered benefits. In this way, the presence of icons 840-2 and 840-3 next to query result 830-2 may indicate that multiple enabling organizations are providing a benefit related to query result 830-2 or to the query 820.

Alternatively, different icons may correspond to different classes of benefits. For example, square icons such as icon 840-2 may indicate benefits of a first type (e.g., a percentage reduction on the cost of an item), and circular icons such as icon 840-3 may indicate benefit of a second type (e.g., cash back). Multiple icons, such as icons 840-2 and 840-3, may be sorted according to a ranking of ratings of benefits as previously described.

The user may click on (or select in another suitable manner) icon 840-1, 840-2, or 840-3 to access information about the relevant benefit, or the user may move an input selection tool (e.g., cursor) over the icon to display information about the relevant benefit via a floating tooltip or caption. Information about an enabling organization that provides such benefit(s) may be displayed instead of or in addition to information about the benefit(s) themselves.

In some embodiments, rather than displaying multiple icons next to a single query result, only one icon is displayed (or not displayed) next to each query result to indicate that benefit(s) related to that query result are available (or are not available). In other words, the icons may serve as binary indicators of the availability (or lack thereof) of related benefits.

In FIG. 9, another mechanism for displaying integrated search and benefit information is shown. In browser window 900, an icon 910 may indicate whether the user is logged in to system 150, similar to FIG. 8. Query 920 may be entered, and query results 930-1, 930-2, 930-3 may be displayed, in a manner similar to FIG. 8. In pane 935, information about various benefits 940-1, 940-2 related to a query result or the search query may be displayed, e.g., as text in a manner similar to advertisements.

Thus, various embodiments provide the user the option to use traditional search engines to obtain results regarding benefits or to visit a portal focused on benefits as described above. Such a portal may itself include search engine functionality. For example, a website that provides an interface to system 150 may include search functionality The user may have the flexibility to choose the manner of searching for benefits that is most convenient to her.

The icons and/or text messages of FIGS. 8 and 9 may be selected by the user to provide the user with varying amounts of relevant information, because the user may expect to receive different amounts of benefit-related information in different contexts. In some situations the user may wish to buy a product quickly with minimal interruptions in the way of benefit-related information. For example, a user may need to step into a store to purchase a tie to wear to a meeting for which he is running late. In such a situation, a user may not want detailed information about different tie vendors or ratings, as that might overload the user with surplus information. Rather, he may simply want to know whether a benefit is available to him that is applicable to his purchase, and if so, how to access the benefit (e.g., by using a particular credit card and presenting a discount code).

In other situations, a user may wish to receive more detailed benefit-related information. A user shopping from home and who knows what he wants to buy may be in a position to shop around, compare offers, and research various deals. In such a situation, a user may want comprehensive information about benefits.

Various embodiments support differing shopping scenarios such as the ones listed above by providing different modes of information presentation. For example, application 116 may provide the user an option to select a first mode (e.g., a “buy” mode), in which the user is informed of the existence of an applicable benefit and the necessary steps for the user to use the benefit. If multiple benefits are available to the user, a highest rated benefit may be displayed in the buy mode.

Application 116 may also provide the user an option to select a second mode (e.g., a “shop” mode), in which the user is informed of not just the existence of an applicable benefit and how to use it, but additionally is informed of all applicable benefits, any associated ratings, and/or information about other enabling organizations to which she is not currently affiliated that may offer better benefits. In the shop mode, the user may be redirected to a portal that provides such detailed information about benefits.

Application 116, which may be a browser plug-in, may remain running to enable the user to switch between different modes at any time. In this way, the user may choose at her convenience the amount of benefit-related information to receive and may not have to make such a selection at the time of each search query. For example, in a first mode (e.g., “buy” mode), a message displayed to the user may include a first information set, and in a second mode (e.g., “shop” mode), the message may include a second information set. The first and second information sets may include data such that “shop” mode provides more comprehensive data to the user than “buy” mode. The first information set may include a first datum (e.g., an indication of an available benefit, or alternatively an instruction or protocol the user should follow to redeem the available benefit), and the second information may include the first datum and at least one other datum not in the first information set. For example, the second information set may additionally include a listing of enabling organizations offering a relevant benefit but to which the user is not currently affiliated. Such additional data may be valuable to a user who is shopping at her leisure (e.g., in “shop” mode) but might be more data than a user in “buy” mode (who may be in a hurry, for example) might want to receive. Mode selection may also be provided outside the context of search engine functionality, e.g., via a mobile application running on the user's terminal. Alternatively, a web portal that the user visits to access information about benefits may allow the user to select the mode. The mode may be selected initially upon loading the portal website, at a time preceding entry of consumer interest data, or at any other time. For example, if user preferences are maintained by the portal, one such preference may be the mode specifying the amount of information the user wishes to receive.

In some embodiments, a user may view benefit information related to various enabling organizations that has been previously aggregated (supplied), and she may then decide whether to join any of the enabling organizations based on that information. For example, referring to the example of FIG. 1A, a user 110-i (not shown) who desires benefit B4 may see the benefit information aggregated due to the inputs from other affiliates who uploaded benefit information, auxiliary information, or ratings related to benefit B4. Viewing such information may help user 110-i decide if enabling organization 120-3, which offers benefit B4, is worth joining. Alternatively, if multiple enabling organizations offer a particular desired benefit, viewing consolidated information related to such benefit for all such enabling organizations may assist her with decision making. In some embodiments, user 110-i may simply browse the aggregated information pertaining to various benefits and enabling organizations. Alternatively, user 110-i may input consumer interest data related to goods or services she desires, and the system 150 may automatically suggest applicable enabling organizations.

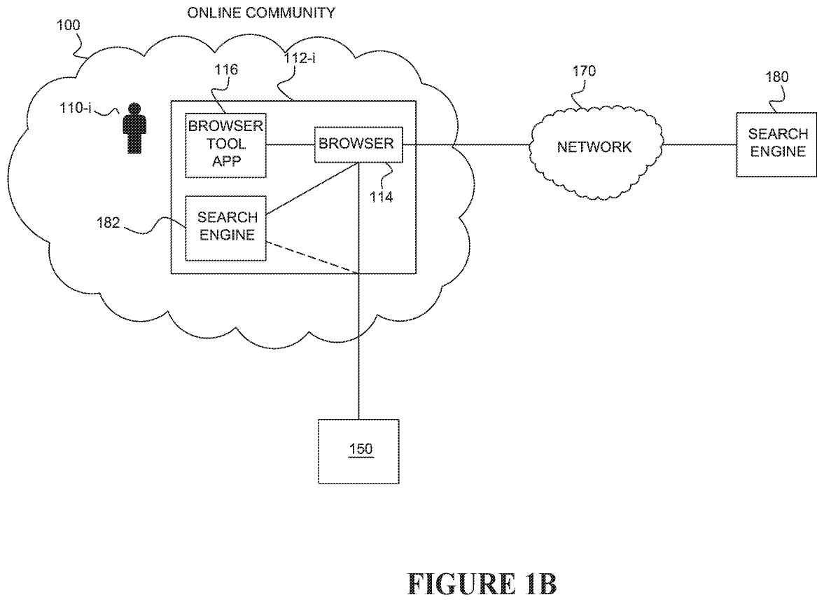

FIG. 2 illustrates one example of an architecture of a computer system 200 in accordance with some embodiments. Computer system 200 may be illustrative of computer system 150 of FIG. 1A. As illustrated in FIG. 2, computer system 200 may include one or more processors 202. Each processor 202 is connected to a communication infrastructure 206 (e.g., a communications bus, cross-over bar, or network). Computer system 200 may include a display interface 222 that forwards graphics, text, and other data from the communication infrastructure 206 (or from a frame buffer not shown) for display on the display unit 224.

Computer system 200 may also include a main memory 204, such as a random access memory (RAM), and a secondary memory 208. The secondary memory 208 may include, for example, a hard disk drive (HDD) 210 and/or removable storage drive 212, which may represent a floppy disk drive, a magnetic tape drive, an optical disk drive, a memory stick, or the like as is known in the art. The removable storage drive 212 reads from and/or writes to a removable storage unit 216. Removable storage unit 216 may be a floppy disk, magnetic tape, optical disk, or the like. As will be understood, the removable storage unit 216 may include a computer readable storage medium having tangibly stored therein (embodied thereon) data and/or computer software instructions, e.g., for causing the processor(s) to perform the operations of the above-described computer-implemented methods for matching a consumer to available benefits.

In alternative embodiments, secondary memory 208 may include other similar devices for allowing computer programs or other instructions to be loaded into computer system 200. Secondary memory 208 may include a removable storage unit 218 (which may be similar to removable storage unit 216) and a corresponding interface 214, which may be similar to removable storage drive 212. Examples of such removable storage units include, but are not limited to, USB or flash drives, which allow software and data to be transferred from the removable storage unit 218 to computer system 200.

Computer system 200 may also include a communications interface 220. Communications interface 220 allows software and data to be transferred between computer system 200 and external devices such as a server. Examples of communications interface 220 may include a modem, Ethernet card, wireless network card, a Personal Computer Memory Card International Association (PCMCIA) slot and card, or the like. Software and data transferred via communications interface 220 may be in the form of signals, which may be electronic, electromagnetic, optical, or the like that are capable of being received by communications interface 220. These signals may be provided to communications interface 220 via a communications path (e.g., channel), which may be implemented using wire, cable, fiber optics, a telephone line, a cellular link, a radio frequency (RF) link and other communication channels.

In this document, the terms “computer program medium” and “computer readable storage medium” refer to media such as media at removable storage drive 212, or a hard disk installed in hard disk drive 210, or removable storage unit 216. These computer program products provide software to computer system 200. Computer programs (also referred to as computer control logic) may be stored in main memory 204 and/or secondary memory 208. Computer programs may also be received via communications interface 220. Such computer programs, when executed by a processor, enable the computer system 200 to perform the features of the methods discussed herein. For example, main memory 204, secondary memory 208, or removable storage units 216 or 218 may be encoded with computer program code (instructions) for performing operations the above-described computer-implemented methods for matching a consumer to available benefits.

In an embodiment implemented using software, software instructions may be stored in a computer program product and loaded into computer system 200 using removable storage drive 212, hard drive 210, or communications interface 220, for example. In other words, the computer program product, which may be a computer readable storage medium, may have instructions tangibly embodied thereon. The software instructions, when executed by a processor 202, cause the processor 202 to perform the functions of (operations of) methods described herein, e.g., in processes 300, 400, 500, 600, and 700. In another embodiment, the method may be implemented primarily in hardware using, for example, hardware components such as a digital signal processor comprising application specific integrated circuits (ASICs). In yet another embodiment, the method is implemented using a combination of both hardware and software.

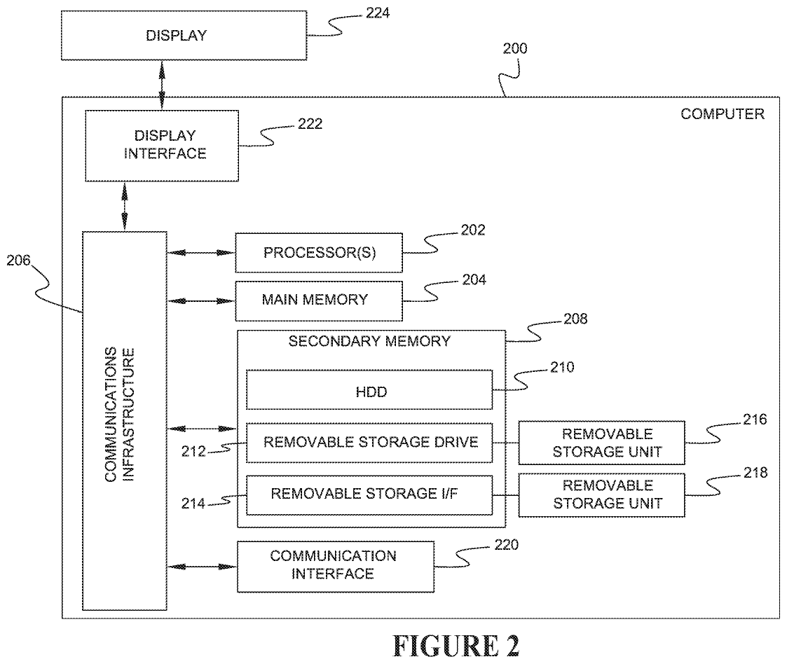

FIG. 3 is a flow diagram in accordance with some embodiments. After process 300 begins, the method may include receiving (310), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (320) pertaining to an enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (330). The consumer interest data, enabling organization information, and benefit information may be analyzed automatically (340) in the computer system to determine whether any enabling organization to which the consumer is affiliated is offering a benefit for the consumer that is applicable to the consumer interest data. A message may be displayed (350) to inform the consumer of an available benefit applicable to the consumer interest data.

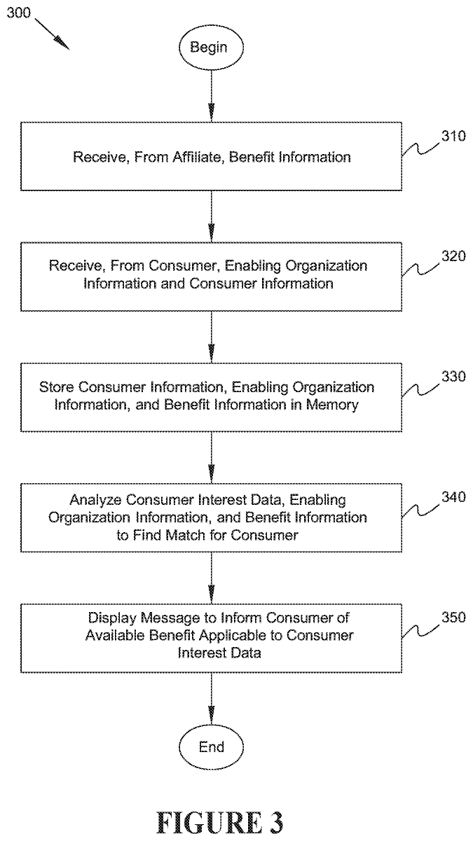

FIG. 4 is a flow diagram in accordance with some embodiments. After process 400 begins, the method may include receiving (410), from a consumer, enabling organization information pertaining to an enabling organization, among a plurality of enabling organizations, to which the consumer is affiliated and consumer information. The consumer information may include consumer identification information for identifying the consumer and consumer interest data for identifying at least one interest of the consumer. The method also includes providing benefit information (420) pertaining to a benefit offered by one of the enabling organizations. In a memory of a computer system, the consumer information, enabling organization information, and benefit information may be stored (430). A rating of one of the benefits offered by that one enabling organization may be received (440) from an affiliate of that enabling organization. The consumer interest data, enabling organization information and benefit information may be analyzed automatically (450) in the computer system to determine whether any enabling organization to which the consumer is affiliated is offering a benefit for said consumer that is applicable to the consumer interest data. A message may be displayed (460) to inform the consumer of an available benefit applicable to the consumer interest data and may include the ratings and/or evaluations of that benefit provided by other affiliates, consumers, or users.

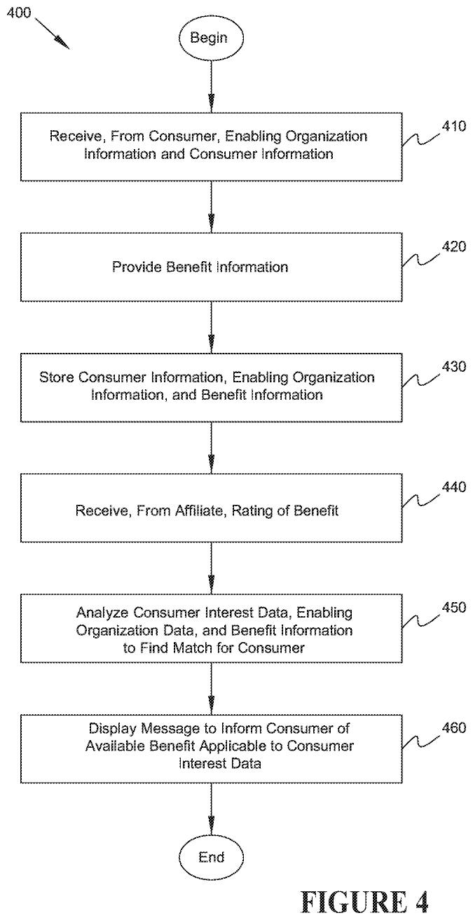

FIG. 5 is a flow diagram in accordance with some embodiments. After process 500 begins, the method may include receiving (510), from a consumer, enabling organization information pertaining to an enabling organization, among a plurality of enabling organizations, to which the consumer is affiliated and consumer information. The consumer information may include consumer identification information for identifying the consumer and consumer interest data for identifying at least one interest of the consumer. The method includes providing benefit information (520) pertaining to a benefit offered by one of the enabling organizations. In a memory of a computer system, the consumer information, enabling organization information, and benefit information may be stored (530). The consumer interest data, enabling organization information, and benefit information may be analyzed automatically (540) in the computer system to determine whether any enabling organization to which the consumer is affiliated is offering a benefit for the consumer that is applicable to the consumer interest data. In an event no benefit applicable to the consumer interest data is currently available, a message may be displayed (550) to inform the consumer that he/she will be notified of a future benefit match. The consumer may be notified of a benefit applicable to the consumer interest data that subsequently becomes available (560).

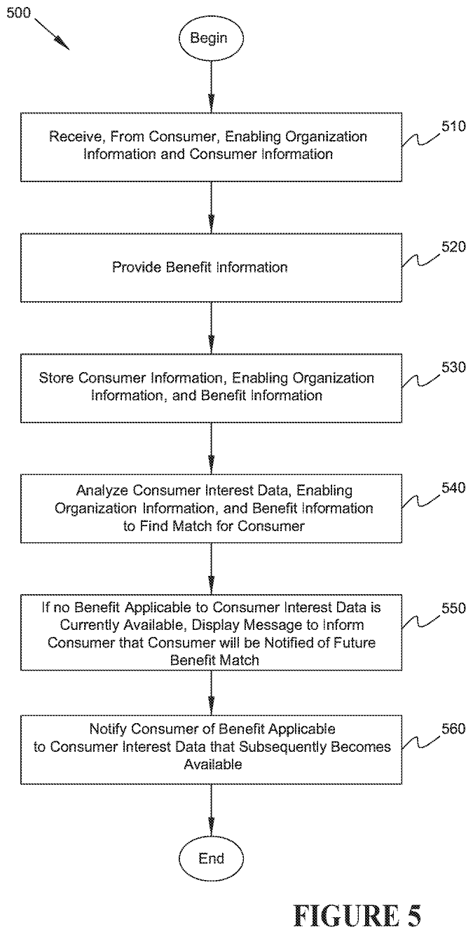

FIG. 6 is a flow diagram in accordance with some embodiments. After process 600 begins, the method may include receiving (610), from an affiliate of one enabling organization, benefit information pertaining to at least one benefit that the affiliate knows is offered by the enabling organization. From a consumer, enabling organization information may be received (620) pertaining to the enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (630). The consumer interest data, enabling organization information, and benefit information may be analyzed automatically (640) in the computer system to determine whether the enabling organization is offering a benefit for the consumer that is applicable to the consumer interest data. A message may be displayed (650) to inform the consumer of an available benefit applicable to the consumer interest data.

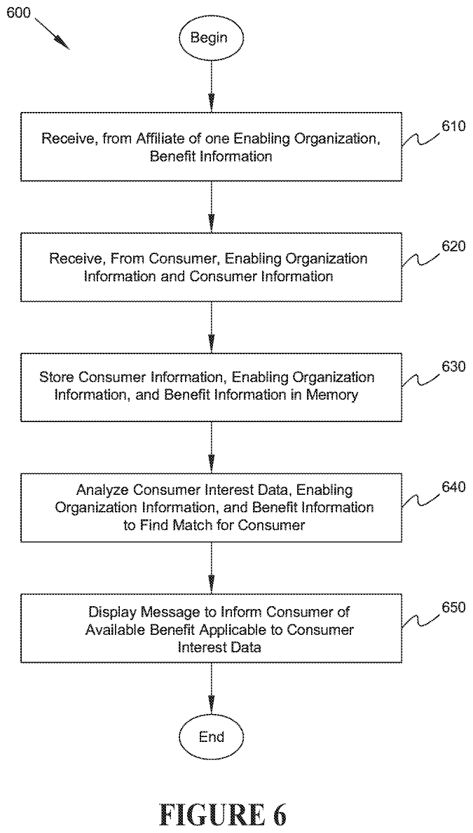

FIG. 7 is a flow diagram in accordance with some embodiments. After process 700 begins, the method may include receiving (710), from a consumer, enabling organization information pertaining to an enabling organization, among multiple enabling organizations, to which the consumer is affiliated. Consumer information may also be received (720), including consumer identification information for identifying the consumer and consumer interest data for identifying at least one interest of the consumer. The method may include providing (730) benefit information pertaining to at least one benefit offered by one of the enabling organizations. In a memory of a computer system, the consumer information, enabling organization information, and benefit information may be stored (740). The consumer interest data, enabling organization information and benefit information may be analyzed automatically (750) in the computer system to determine whether any enabling organization to which the consumer is affiliated is offering a benefit for the consumer that is applicable to the consumer interest data. A message may be displayed (760) to inform the consumer of a first available benefit and a second available benefit. The first available benefit may be applicable to the consumer interest data offered by a first enabling organization to which the consumer is affiliated. The second available benefit may be superior to the first available benefit according to a predetermined metric. The second available benefit may be applicable to the consumer interest data and may be offered by a second enabling organization to which the consumer is not affiliated.

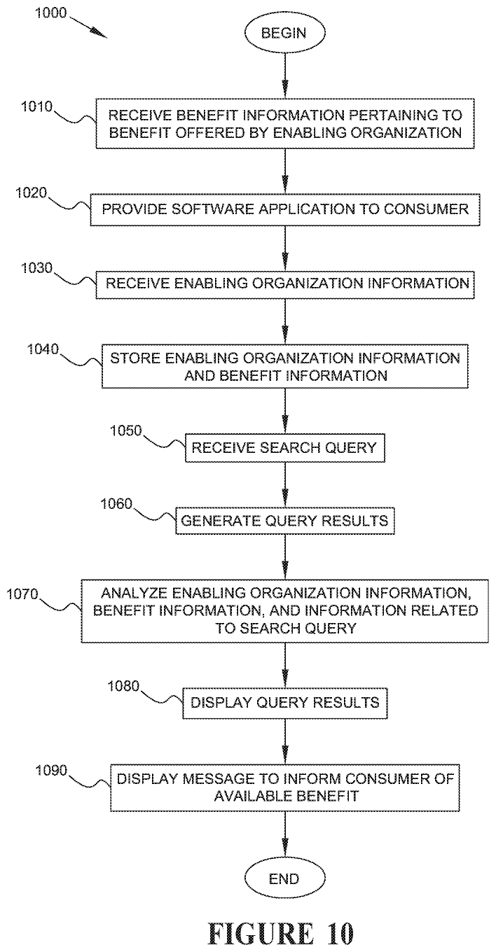

FIG. 10 is a flow diagram in accordance with some embodiments. After process 1000 begins, the method may include receiving (1010), from a first affiliate of one of multiple enabling organizations, benefit information pertaining to at least one benefit the affiliate knows is offered by that enabling organization. A software application may be provided (1020) to a consumer. Enabling organization information may be received (1030) from the consumer via the software application. The enabling organization pertains to an enabling organization to which the consumer is affiliated. Consumer identification information may also be received, which identifies the consumer. In a memory of a computer system, the enabling organization information and benefit information may be stored (1040). A search query including consumer interest data from the consumer may be received (1050) at a search engine. The search query need not be related to benefits or enabling organizations but may be a general search query such as is commonly entered at familiar search engines. One or more query results may be generated (1060) with the search engine responsive to said search query. The enabling organization information, benefit information, and information related to the search query may be analyzed (1070) automatically in the computer system to determine whether any enabling organization to which the consumer is affiliated is offering a benefit for that consumer that is applicable to the consumer interest data. The query results may be displayed (1080). Adjacent to the displayed query results, a message may be displayed (1090) to inform the consumer of an available benefit applicable to the consumer interest data.

In particular embodiments of the present disclosure, a Search Score Algorithm may be used such that search results responsive to a search entered by a consumer (e.g., based on the consumer's consumer interest data) will be presented to the consumer in a list ordered such that the most relevant search results are displayed at the top of the list. In an embodiment, the Search Score Algorithm includes a set of metadata, functions, and/or processes which together allow for the results of a consumer's search to be scored against a variety of factors/values which are then distilled into a single numeric “score”. This “score” may then be used to sequence and/or filter the search results in a manner that highlights the most potentially relevant/valuable items before those deemed of less importance to the requesting consumer. As a non-limiting example, if a consumer submits a set of search parameters to the system, a search engine within the system (e.g., CPU 152 in system 150, as shown in FIG. 1) would locate a set of offers/benefits matching the consumer's parameters and then pass those search results to the Search Score Algorithm to sequence them from most relevant to least relevant. As a non-limiting example, if a member performs a search for “dining within 10 miles of the consumer's present location”, a search result/offer/benefit regarding a venue that is 1.1 miles away from the consumer with an average rating of 4.4 stars and an average member savings of $14 may outrank an offer that was 0.5 miles away from the consumer's location but had a lower average rating and/or a lower average member savings. The consumer could also filter out search results having a “score” less than a certain predetermined threshold.

The Search Score Algorithm may include a complex set of factors/values that leverage a variety of data inputs, such as:
Venue Geographic Proximity (“VGP”): where venues that are closer to the consumer's current location may typically rank higher than those venues that are farther away from the consumer's current location. In an embodiment, the VGP relies on personalized data (e.g., the specific consumer's location) that can be internally sourced (e.g., using the venue's record geo-location coordinates).
Venue Rating (“VR”): where venues with a higher rating rank higher than those with a lower rating. In an embodiment, the VR relies on global data (e.g., data that is the same for all members of the online community) that can be internally and/or externally sourced (e.g., ratings of venues directly provided by members of the online community itself; 5-Star Rating information obtained from external sources).
Offer/Benefit Value (“OBV”): offers/benefits that deliver more savings to the consumer rank higher than those with less savings to the consumer. Some offers/benefits may have a clear, stated value (e.g., “Save $2 on a Medium Drink”), and feedback can be directly provided by members of the online community recording their actual savings as a result of utilizing a specific offer/benefit (e.g., “I saved $X with this offer/benefit”). In an embodiment, the OBV relies on global data that can be internally sourced.
Offer/Benefit Interest (“OBI”): offers/benefits with more member interest rank higher than those with less member interest. In an embodiment, the OBI relies on global data that can be internally sourced (e.g., like/dislike, sharing, rating, survey questions, etc. directly provided by members within the online community itself).
Offer/Benefit Activity Matching (“OBAM”): offers/benefits with content matching a consumer's activity rank higher than those without. In an embodiment, the OBAM relies on personalized data that can be internally and/or externally sourced (e.g., frequent member search keywords, frequently visited geo-location coordinates, interests and content found in the consumer's connected Facebook profile and/or other external sources, typically accessed with permission of the consumer).

In an embodiment, once each of the above factors/values has been determined, the resulting factors/values are then collated and distilled into a single numeric “score” (i.e., the Search Score (“SS”)) that can be used to sequence and/or filter the search results responsive to the consumer's search request. In a further embodiment, the rankings from each factor/value are not simply summed, but rather each factor/value is assigned a certain predetermined amount of weight which is used to factor the individual factor/values together to create the Search Score. The individual weight applied to any particular factor/value may be unique in comparison with the other applied weights, the weights may all be the same, or two or more of the individual weights may be the same while the others are different. In still a further embodiment, in the event certain venues/offers/benefits may not have the input data necessary to support a particular factor/value, that particular factor/value would not be included in the Search Score Algorithm calculation.

As a non-limiting example, a Search Score (“SS”) may be determined using the following equation:

SS=(VGP*w₁)+(VR*w₂)+(OBV*w₃)+(OBI*w₄)+(OBAM*w₅)

where: w₁=a first predetermined weight
w₂=a second predetermined weight
w₃=a third predetermined weight
w₄=a fourth predetermined weight
w₅=a fifth predetermined weight.

In an embodiment, the weights may initially have a predetermined default value. In other embodiments, one or more of the weights may be changed by the consumer. In further embodiments, one or more of the weights may be automatically updated based on the consumer's behavior, e.g., purchase history, search history, location, payment method, etc. In still further embodiments, one or more of the weights may be automatically updated based on the behavior of a group of consumers that are similar in some way to the particular consumer, e.g., demographically, geographically, based on similar interests (club membership, job type, vacation locations, etc.)

In another embodiment, the Search Score Algorithm would not necessarily be static. Rather, the Search Score Algorithm would be subject to continual refinement, updates, and adjustments as experience dictates. For example, the relative weighting of the factors mentioned above may be changed. For another example, new sources of relevant information may become available that can be incorporated into the various factors, thereby influencing the resulting Search Score Algorithm.

In a further embodiment, the embodiments of the disclosed system and method may include the capability to notify a user that a previously-entered search query by the user has been met by a benefit added to the system after the query was entered. As a non-limiting example, a user may enter a query into the computer system 150 of FIG. 1, as described above. The user may opt to have the query stored in a database, e.g., in memory 154 of computer system 150, regardless of whether the system informs the user at the time the query is entered that one or more benefits have been found to match the user's query. If a benefit is later entered into the system, e.g., a new benefit is added by an affiliate, the system may then automatically prompt the user that a benefit fulfilling the user's query exists. The user may set a time frame for when the query should remain active in the system. Additionally, the user may enter other settings such as geographic location of the user. or type of benefit desired (e.g., have the system only report benefits that are 10% off or better), or has at least a particular user rating or venue rating, etc., as discussed above.

In a still further embodiment, the Search Score Algorithm will include at least two primary sorting terms and at least three secondary sorting factors. In a particular embodiment, the primary sorting terms include Venue Geographical Proximity, as described above and including one or both of how near or far a venue is from the current position of the consumer or from a user-defined location that is different than the consumer's current location, and Venue Rating, as described above. In a further particular embodiment, the secondary sorting factors include Offer/Benefit Value, as described above, Offer/Benefit Interest, as described above, and Offer/Benefit Activity Matching, as described above. As a non-limiting example, a consumer may submit search parameters to a search engine (e.g., CPU 152 in system 150, as shown in FIG. 1) and select one of the at least two primary sorting terms so that the search engine returns search results responsive to the search parameters that are sorted based on the selected primary sorting term. The consumer may then order the returned search results based on one or more of the secondary sorting factors. Alternatively, the consumer may select one or more of the primary sorting terms on a relative basis, i.e., the methodology/system may allow the consumer to set a value for a first of the primary sorting terms from a range of values, such as a sliding scale, and another value (either the same or different) for a second of the primary sorting terms. Similarly, the consumer may select the secondary sorting factors in an analogous fashion. The system may present the consumer with, e.g., sliders, drop down menu, radio buttons, user entry box, etc., that allow the consumer to select an appropriate value for one or more of the primary sorting terms and/or the secondary sorting factors. In an embodiment, the sliders, etc. may allow the consumer to select a value from one to ten, one to five, etc., where “one” signifies a low (i.e., less important) score and “five” or “ten” signifies a high (i.e., more important) score. Default values for each of the primary sorting terms and/or the secondary sorting factors may be a predetermined number, such as “five” for a one-to-ten scale.

In another embodiment, the consumer may instruct the search engine to return search results responsive to the consumer's entered search parameters where the search results are based on a proximity factor relative to the consumer's current or chosen location, a popularity factor for the venue, which may be a rating from an outside source such as, e.g., Zagat, Michelin, Yelp, etc., and a value/rating factor, which may be based on the amount of activity a venue has received as based on the search engine system 150 and/or a rating value that users of the system have input to the search engine system. In an embodiment, the popularity factor may be a mixture of ratings from outside sources and rating of system users.

In still another embodiment, the method and/or system 150 may include a feedback mechanism where a consumer may review a benefit received from the search engine. As a non-limiting example, the feedback mechanism may include a factor based on the approximate cost of the benefit and the approximate savings represented by the benefit. These two subfactors may be combined to create the feedback factor which may represent a percentage savings to the consumer from the use of the benefit. This feedback factor may be used as input to the value/rating factor discussed above. The feedback mechanism may further include an optional short text entry portion in which the consumer may enter pertinent information regarding the benefit.

A further embodiment includes the use of an algorithm that takes into account information the system 150 gleans from a particular consumer's history of using the system, such as, but not limited to, the types of venue the particular consumer typically searches for (e.g., flower shops, restaurants, taxis, shoe stores, gas stations, etc.), the frequency of those searches, either absolute or as a percentage of total searches, the price level of the venues typically searched (e.g., high-end hotels, expensive restaurants, etc.), the rating of the venues typically chosen (either internal ratings, external ratings, or a combination of both), etc. The methodology and/or system 150 may then use this consumer-specific information and combine it with geolocation information (of one or both of the consumer and a venue), the amount of time the consumer has spent at that particular venue, and then push out to the consumer benefit information for that venue without requiring the consumer to initiate a benefit search. As a non-limiting example, a consumer may be passing by clothing store A which the system knows the consumer has never used a benefit from the system for that store. However, when the consumer detects that the consumer has spent a particular amount of time inside the store (e.g., five minutes, ten minutes, etc.) based on geolocation information for the consumer and clothing store A, the system will automatically push out a benefit to the consumer for clothing store A. Further, the system may additionally (or instead of) automatically push out a benefit to the consumer for clothing store B (which the system knows the consumer has used a benefit from the system for in the past) along with a distance and/or directions from the consumer's current location to clothing store B. As another non-limiting example, a consumer may be passing by flower shop A. The system, which is receiving geolocation input from the consumer and therefore knows the consumer is passing by flower shop A, the system knows the consumer has used a benefit for flower shop A in the past, and further the system knows that the consumer is entitled to a 10% discount at flower shop A because he is a member of a particular alumni association, and still further the system knows that the consumer is entitled to an additional 5% discount if he uses credit card B. Therefore, the system may push out all this benefit information to the consumer either immediately or after the consumer has remained in the vicinity of flower shop A for a predetermined amount of time. Some or all of these automatic functions may be turned on or off by the consumer. The consumer may also set the predetermined loiter time and/or a distance to a particular venue for when the system may push out a benefit.

In certain embodiments, the systems and methods described herein may provide the user with curated search results. These curated search results may be achieved in at least three ways. First, the user may enter a search request into the system and the system may return search results based on information the system had previously learned about the user, as discussed above. Second, the system may automatically perform a search (which is a feature that the user may enable or disable) based at least in part on the user's geolocation (e.g., via GPS or any other geolocation means) and/or a loiter time for the user in a particular location, such as in front of or within a store, as described above. The system may store the search results either remotely from the user (e.g., in a cloud database) or locally on the user's electronic communication device. If the user then has a desire to know if he is near a store in which he has a discount, the user need only access the system's application and the results would be shown to the user without the user having to enter any search terms. Third, as described above, the system would perform a search based at least in part on the user's geolocation and push out a notification of any deals/discounts applicable to the user based on the system's knowledge of the user. This feature may be enabled or disabled by the user.

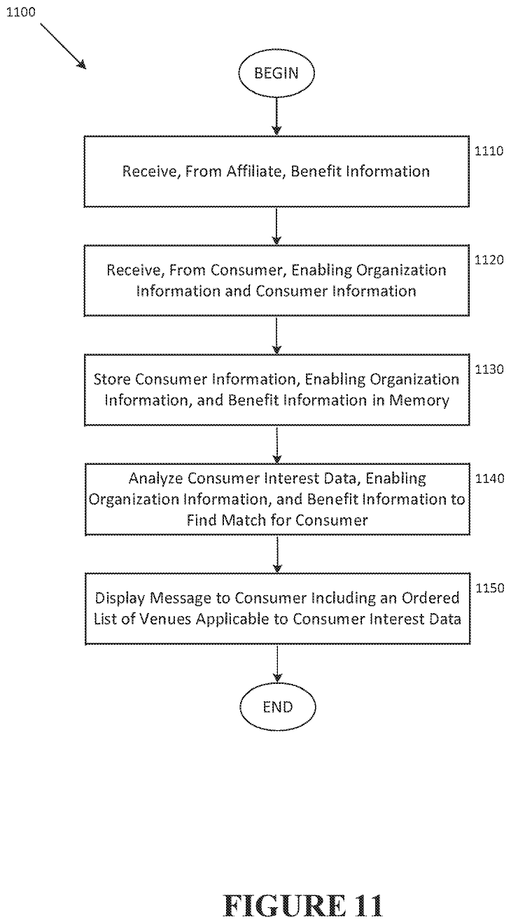

With reference to FIG. 11, a flow diagram in accordance with some embodiments is presented. After process 1100 begins, the method may include receiving (1110), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (1120) pertaining to an enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (1130). The consumer interest data, enabling organization information, and benefit information may be analyzed automatically (1140) in the computer system to determine whether any enabling organization to which the consumer is affiliated is offering a benefit for the consumer that is applicable to the consumer interest data. A message may be displayed (1150) to inform the consumer of a list of a plurality of venues that are applicable to the consumer's interest data. The list of venues may be ordered in a number of ways including, but not limited to, the Search Score (“SS”) discussed above, or according to a predetermined primary sorting term selected by the consumer discussed above.

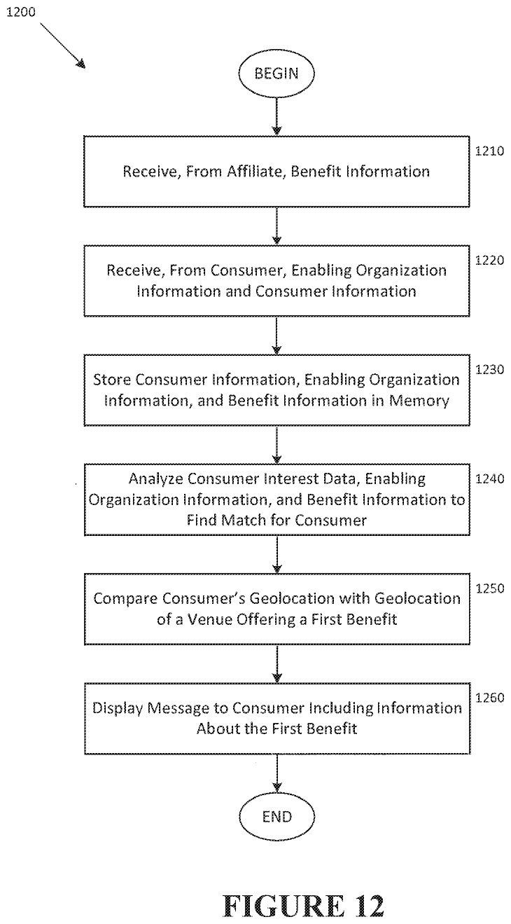

With reference to FIG. 12, a flow diagram in accordance with some embodiments is presented. After process 1200 begins, the method may include receiving (1210), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (1220) pertaining to an enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (1230). The consumer interest data, enabling organization information, and benefit information may be analyzed automatically (1240) in the computer system to determine whether any enabling organization to which the consumer is affiliated is offering a benefit for the consumer that is applicable to the consumer interest data. A comparison may be made (1250) between the consumer's current geolocation and the geolocation of a venue associated with one of the plurality of enabling organizations offering a first benefit. A message may be displayed (1260) to inform the consumer of information regarding the first benefit.

In a still further embodiment, the methodology and/or system 150 may use the consumer-specific information and geolocation information (of one or both of the consumer and a venue) as discussed above, and factor in the relative speed of the consumer with respect to the venue as one of the determining factors as to whether consumer benefit information is pushed out to the consumer. As a non-limiting example, where the venue is a restaurant and the consumer, in a first instance, is driving down the street at speed S1, and in a second instance, the consumer is walking down the street at speed S2, where S1>S2, the methodology and/or system 150 may take the consumer's speed into account in determining whether or not to push out a benefit (e.g., a special on the lunch menu) to the consumer. The consumer traveling at S1 may not be interested in a lunch special as indicated by high speed S1 whereas the consumer traveling at S2 (which may be, e.g., a walking pace or stationary) may be interested in a lunch special. In yet still another embodiment, the consumer's electronic device which receives the benefit information may be programmed, either manually by the consumer or automatically by the methodology and/or system 150, to filter out and/or not display any benefit information if the consumer's speed is greater than a threshold value. This filtering function may be for all benefit information received or for select benefit information received as determined by either the consumer or the methodology and/or system 150.

In another embodiment, the electronic device that the consumer uses to receive benefit information from the methodology and/or system 150 may include communications technology built in to an automobile. In such a case, in certain embodiments the communication technology may be modified to connect to engine performance and/or maintenance data (e.g., check engine light, fuel tank level sensor, engine overheating alarm, windshield washer fluid level sensor, oil pressure sensor, etc.) such that when a threshold is reached and/or alarm condition is sensed the methodology and/or system 150 is alerted which then sends benefit information to the consumer related to car gas stations, automotive repair and maintenance shops, etc. that are, preferably, local to the consumers then-current position.

In another embodiment, the methodology and/or system 150 may be connected to Companies 1 through N each of which includes a database of people in a respective loyalty program. The methodology and/or system 150 then acts as an aggregator of these Company 1 through N databases and allows the users in these databases to, for example, sign up for a loyalty program that methodology and/or system 150 has available (e.g., a credit card program). The owner of the methodology and/or system 150 may charge a small finder's fee for the service. The owner of the methodology and/or system 150 may then approach the credit card company with now a relatively large number (aggregated from the Company 1 through N databases) of new credit card program purchasers and the owner of the methodology and/or system 150 may also charge the credit card company a small finder's fee.

In a further embodiment, benefits available to a consumer at a particular venue may be aggregated with applicable coupons for that same venue. The applicable coupons may or may not originate from, or be supplied by, the same source (e.g., a common enabling organization or common affiliate) as the other benefits for which the consumer is taking advantage. As a non-limiting example, a consumer may wish to purchase flowers at a flower shop. The consumer may search through a benefit matching system, as described in any of the embodiments above (including embodiments where information is pushed to the consumer without a specific search), and discover that one enabling organization or affiliate has one or more coupons available for the flower shop and another (or the same) enabling organization or affiliate provides a 5% discount on purchases with a particular credit card. The consumer may choose to aggregate an available coupon with the credit card discount and thus increase the savings available to the consumer on the purchase of flowers. As another non-limiting example, a consumer may wish to purchase dinner at a particular restaurant and the consumer may be informed by the benefit matching system that a first enabling organization or affiliate awards points or coupons for dining at the restaurant on Tuesdays, where those points or coupons may be used for some future purchase either at the restaurant or at another venue, and a second enabling organization or affiliate (which may be the same as the first), provides a discount on the cost of the meal if the consumer is a member of the second enabling organization or affiliate. Therefore, the consumer may aggregate these benefits to maximize the consumer's purchasing power.

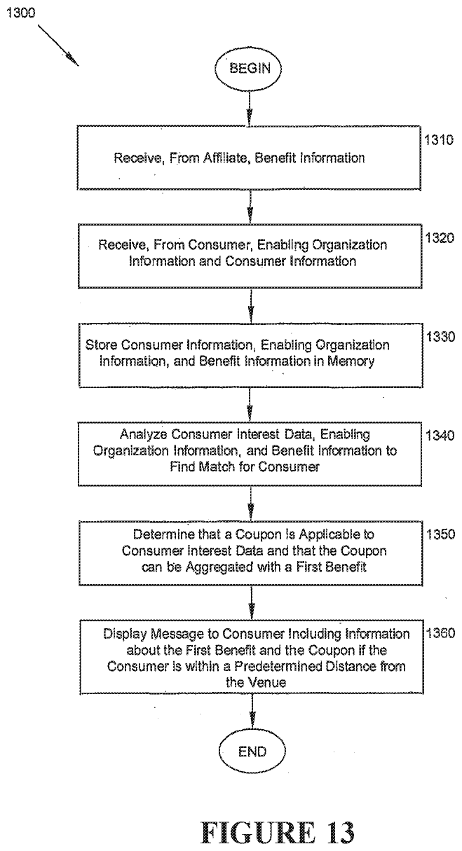

With reference to FIG. 13, a flow diagram in accordance with some embodiments is presented. After process 1300 begins, the method may include receiving (1310), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (1320) pertaining to an enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (1330). The consumer interest data, enabling organization information, and benefit information may be analyzed automatically (1340) in the computer system to determine whether any enabling organization to which the consumer is affiliated is offering a benefit for the consumer that is applicable to the consumer interest data. A determination may be made (1350) that a coupon is applicable to the consumer interest data and offered by a second one of the plurality of enabling organizations, where the consumer is affiliated with the second enabling organization, and that the coupon can be aggregated with the first benefit. A message may be displayed (1360) to inform the consumer of information regarding the first benefit and the coupon upon the condition that the consumer is located within a first predetermined distance from a first venue offering the first benefit. The message may be received on a mobile device of the consumer, such as a hand-held device. In an embodiment, the benefit information may be displayed in a format indicating the source of the benefit information.

In an embodiment, the first predetermined distance is zero. In another embodiment the first predetermined distance is configurable by said consumer. The consumer interest data may include the first predetermined distance. The displayed message may inform the consumer of an actual distance from the current location of the consumer to the first venue offering the first benefit

In a further embodiment, the consumer interest data includes at least one filter configurable by the consumer. The filter may be one of a particular benefit, a particular category of benefits, a particular enabling organization, and combinations thereof.

In other embodiments, the consumer may further receive auxiliary information about the coupon and/or the first benefit, where the auxiliary information includes an expiration date of the coupon and/or first benefit or a link to a website for description or redemption of the coupon and/or the first benefit. In an embodiment, the auxiliary information is received from the first affiliate.

In another embodiment, the auxiliary information is received from a second affiliate of the first enabling organization different from the first affiliate, where the second affiliate has an affiliation with the first enabling organization, the affiliation being a pre-existing relationship with the first enabling organization that enables the second affiliate to obtain at least one benefit from the first enabling organization not otherwise available to the second affiliate, and where the second affiliate is an authenticated member of the online community. In an embodiment, the auxiliary information is received from a moderator of the online community including the first affiliate and the consumer. In another embodiment, the auxiliary information is received from an automated agent configured to automatically provide information to assist members of the online community.

In a still further embodiment, the method shown in FIG. 13 may further include receiving an input from the consumer indicative of the consumer's desire to avail himself or herself of the available benefit and the coupon, and the consumer purchasing a good or service associated with the consumer interest data to execute the available benefit and the coupon.

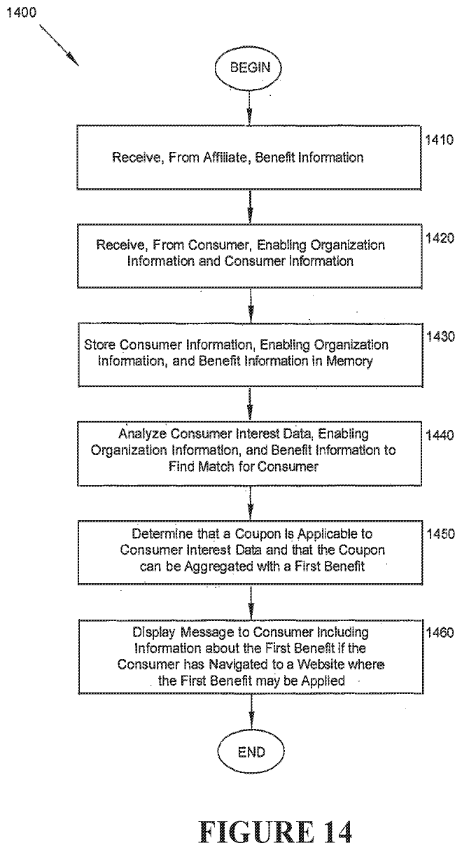

With reference to FIG. 14, a flow diagram in accordance with some embodiments is presented. After process 1400 begins, the method may include receiving (1410), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (1420) pertaining to an enabling organization to which the consumer is affiliated. Consumer information may also be received from the consumer, including consumer identification information for identifying the consumer and consumer interest data for identifying at least one interest of the consumer. In a memory of a computer system, the consumer information, enabling organization information, and benefit information may be stored (1430). The consumer interest data, enabling organization information, and benefit information may be analyzed automatically (1440) in the computer system to determine whether any enabling organization to which the consumer is affiliated is offering a benefit for the consumer that is applicable to the consumer interest data. A determination may be made (1450) that a coupon is applicable to the consumer interest data and offered by a second one of the plurality of enabling organizations, where the consumer is affiliated with the second enabling organization, and that the coupon can be aggregated with the first benefit. A message may be displayed (1460) to inform the consumer of information regarding the first benefit and the coupon upon the condition that the consumer has navigated through a computer network to a website where the first benefit may be applied to the purchase of a good or service offered by the website. The message may be received on a mobile device of the consumer, such as a hand-held device. In an embodiment, the benefit information may be displayed in a format indicating the source of the benefit information.

In a further embodiment, the consumer interest data includes at least one filter configurable by the consumer. The filter may be one of a particular benefit, a particular category of benefits, a particular enabling organization, and combinations thereof.

In other embodiments, the consumer may further receive auxiliary information about the coupon and/or the first benefit, where the auxiliary information includes an expiration date of the coupon and/or first benefit or a link to a website for description or redemption of the coupon and/or the first benefit. In an embodiment, the auxiliary information is received from the first affiliate.

In another embodiment, the auxiliary information is received from a second affiliate of the first enabling organization different from the first affiliate, where the second affiliate has an affiliation with the first enabling organization, the affiliation being a pre-existing relationship with the first enabling organization that enables the second affiliate to obtain at least one benefit from the first enabling organization not otherwise available to the second affiliate, and where the second affiliate is an authenticated member of the online community. In an embodiment, the auxiliary information is received from a moderator of the online community including the first affiliate and the consumer. In another embodiment, the auxiliary information is received from an automated agent configured to automatically provide information to assist members of the online community.

In a still further embodiment, the method shown in FIG. 14 may further include receiving an input from the consumer indicative of the consumer's desire to avail himself or herself of the available benefit and the coupon, and the consumer purchasing a good or service associated with the consumer interest data to execute the available benefit and the coupon.

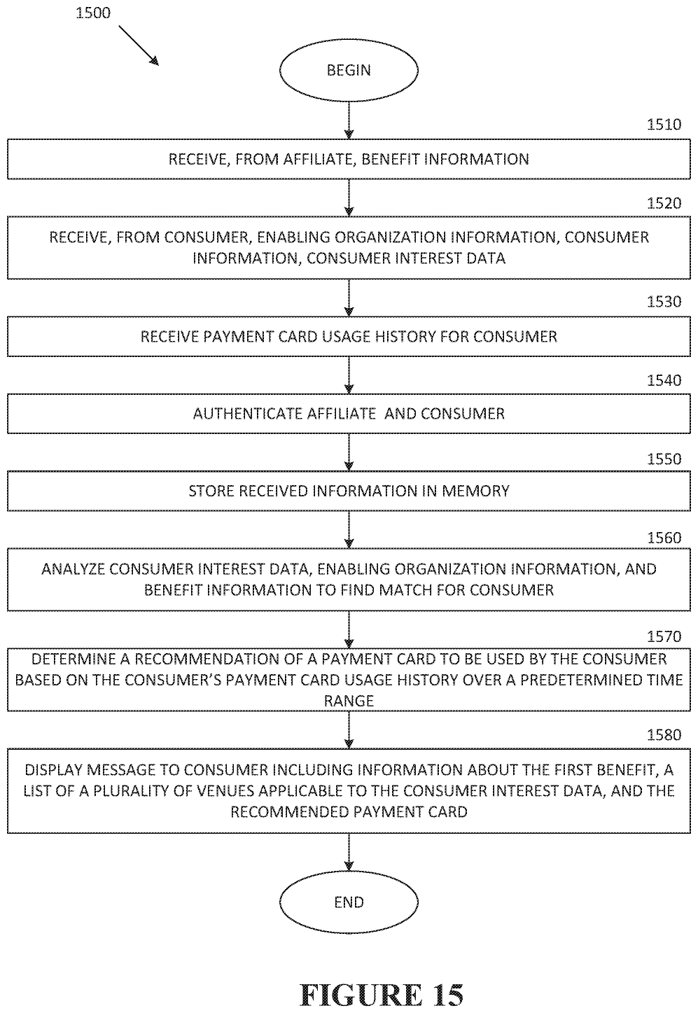

With reference to FIG. 15, a flow diagram in accordance with some embodiments is presented. After process 1500 begins, the method may include receiving (1510), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (1520) pertaining to an enabling organization to which the consumer is affiliated. Consumer information may also be received from the consumer, including consumer identification information for identifying the consumer and consumer interest data for identifying at least one interest of the consumer. Payment card usage history, as described in further detail below, may be received for the consumer (1530). As described in detail above, the first affiliate and the consumer may be authenticated, typically individually (1540). In a memory of a computer system, the consumer information, enabling organization information, and benefit information may be stored along with other received information (1550). The consumer interest data, enabling organization information, and benefit information may be analyzed automatically (1560) in the computer system to determine whether any enabling organization to which the consumer is affiliated is offering a benefit for the consumer that is applicable to the consumer interest data.

A determination may be made (1570) regarding a recommendation for which payment card the consumer might consider using for purchasing an item or service, as will be discussed in detail below. A message may be displayed (1580) to inform the consumer of information regarding the first benefit, a list of a plurality of venues applicable to the consumer interest data, and the payment card recommendation. The message may be received on a mobile device of the consumer, such as a hand-held device. In an embodiment, the benefit information may be displayed in a format indicating the source of the benefit information.

Regarding the payment card recommendation, in an embodiment, the recommendation may be based on the consumer's payment card usage history and/or the consumer's payment history. The recommendation may also be based on a consumer input, where the consumer's input may be used in conjunction with the consumer's payment history of one or more payment cards or may be used, for example, for specific purchases set by the consumer. The consumer's payment card (e.g., credit card, debit card, gift card, etc., and including an electronic payment system and/or method that is not card-based) history may be used to form a decision as to which payment card the consumer should use for a particular purchase. The consumer's payment card usage history may take into account some (which may be selected fully or partly by the consumer and/or fully or partly selected by the system based on a particular algorithm) or all of the user's purchases (e.g., of just similar goods/services to the current purchase or purchases of all goods/services) over a certain time range. These time ranges can be any given time range (e.g., a date range) and are not limited to contiguous or sequential time frames, e.g., the past day, the past week, the past month, the past year, the first week of every month over the past M number of months or the past Y number of years, the same month over the past Y years, the second quarter of each of the past Y years, a time span leading up to, covering, or after an event (e.g., a birthday, anniversary, tax payment due dates, etc.), or any other set of hours/days/weeks/months specific to a spending habit of the consumer. Alternatively, or in addition, to the above, the consumer's payment card usage history may be based on the consumer's particular type of purchases (e.g., restaurant meals, the type of restaurant, automobiles, home improvement items, a corporate or business purchase, flowers, clothes, shoes, purchases in a particular city/town/state/country, purchases from a particular website, etc.) Where necessary, the consumer's permission to access the consumer's payment card usage history will be obtained/requested.

In an embodiment, the process results in an automatic recommendation based on, for example, a modified version of the Search Score Algorithm described above. For example, the modified Search Score Algorithm may include a complex set of factors/values that leverage a variety of data inputs, such as one or more of the following:
Venue Geographic Proximity (“VGP”): where venues that are closer to the consumer's current location may typically rank higher than those venues that are farther away from the consumer's current location. In an embodiment, the VGP relies on personalized data (e.g., the specific consumer's location) that can be internally sourced (e.g., using the venue's record geo-location coordinates).
Venue Rating (“VR”): where venues with a higher rating rank higher than those with a lower rating. In an embodiment, the VR relies on global data (e.g., data that is the same for all members of the online community) that can be internally and/or externally sourced (e.g., ratings of venues directly provided by members of the online community itself; 5-Star Rating information obtained from external sources).
Offer/Benefit Value (“OBV”): offers/benefits that deliver more savings to the consumer rank higher than those with less savings to the consumer. Some offers/benefits may have a clear, stated value (e.g., “Save $2 on a Medium Drink”), and feedback can be directly provided by members of the online community recording their actual savings as a result of utilizing a specific offer/benefit (e.g., “I saved $X with this offer/benefit”). In an embodiment, the OBV relies on global data that can be internally sourced.
Offer/Benefit Interest (“OBI”): offers/benefits with more member interest rank higher than those with less member interest. In an embodiment, the OBI relies on global data that can be internally sourced (e.g., like/dislike, sharing, rating, survey questions, etc. directly provided by members within the online community itself).
Offer/Benefit Activity Matching (“OBAM”): offers/benefits with content matching a consumer's activity rank higher than those without. In an embodiment, the OBAM relies on personalized data that can be internally and/or externally sourced (e.g., frequent member search keywords, frequently visited geo-location coordinates, interests and content found in the consumer's connected Facebook profile and/or other external sources, typically accessed with permission of the consumer).
Payment Card Usage History (“PCUH”): usage history of each of one or more payment cards by the consumer over a predetermined time range, as described above. The PCUH may include, for example, one or more of the following: purchase date and/or time, purchase location, information regarding the item purchased, the amount of the purchase, from whom the purchase was made (e.g., store name, online website address, etc.), discount offered, etc. In certain embodiments the PCUH may be one or more of: purchase specific (e.g., the same good/service or the same type of good/service); date/time specific (e.g., around a birthday day, etc.); location specific (e.g., the same store, the same neighborhood, the same city, etc.); etc.

As described above, as a non-limiting example, a modified Search Score (“SS”) may be determined using the following equation:

SS=(VGP*w₁)+(VR*w₂)+(OBV*w₃)+(OBI*w₄)+(OBAM*w₅)+(PCUH*w₆)

where: w₁=a first predetermined weight
w₂=a second predetermined weight
w₃=a third predetermined weight
w₄=a fourth predetermined weight
w₅=a fifth predetermined weight
w₆=a sixth predetermined weight.

Other variations and/or permutations of the above modified Search Score Algorithm and/or modified Search Score are contemplated herein.

In a further embodiment, the consumer interest data includes at least one filter configurable by the consumer. The filter may be one of a particular benefit, a particular category of benefits, a particular enabling organization, and combinations thereof.

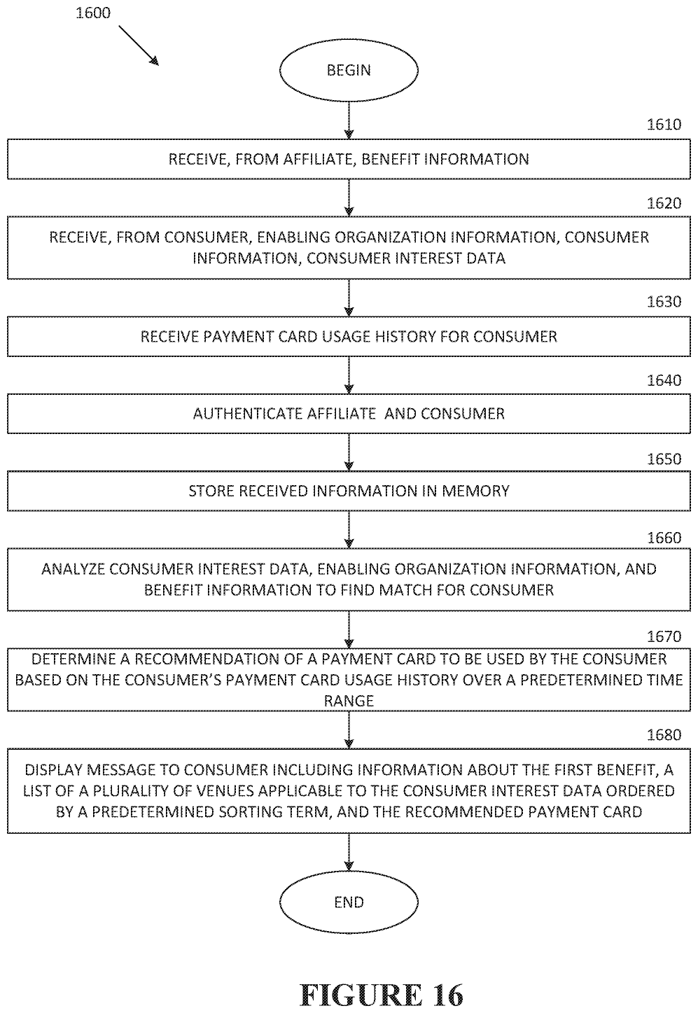

With reference to FIG. 16, a flow diagram in accordance with some embodiments is presented, which is some aspects is similar to the flow diagram for FIG. 15. After process 1600 begins, the method may include receiving (1610), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (1620) pertaining to an enabling organization to which the consumer is affiliated. Consumer information may also be received from the consumer, including consumer identification information for identifying the consumer and consumer interest data for identifying at least one interest of the consumer. Payment card usage history, as described in detail above, may be received for the consumer (1630). As described in detail above, the first affiliate and the consumer may be authenticated, typically individually (1640). In a memory of a computer system, the consumer information, enabling organization information, and benefit information may be stored along with other received information (1650). The consumer interest data, enabling organization information, and benefit information may be analyzed automatically (1660) in the computer system to determine whether any enabling organization to which the consumer is affiliated is offering a benefit for the consumer that is applicable to the consumer interest data.

A determination may be made (1670) regarding a recommendation for which payment card the consumer might consider using for purchasing an item or service, as will be discussed in detail below. A message may be displayed (1680) to inform the consumer of information regarding the first benefit, a list of a plurality of venues applicable to the consumer interest data, where the list of venues is ordered according to a predetermined sorting term as described above, and the payment card recommendation. The message may be received on a mobile device of the consumer, such as a hand-held device. In an embodiment, the benefit information may be displayed in a format indicating the source of the benefit information.

Display Suppression Window

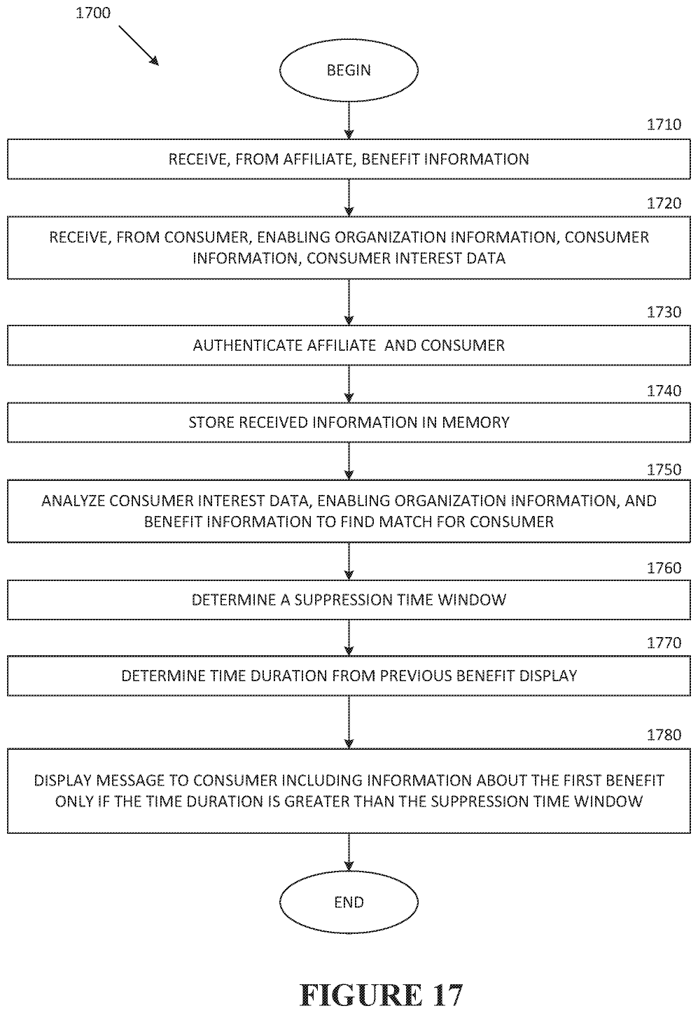

With reference to FIG. 17, a flow diagram in accordance with some embodiments is presented. After process 1700 begins, the method may include receiving (1710), from a first affiliate of an enabling organization, benefit information pertaining to at least one benefit that the affiliate knows is offered by the enabling organization. As stated above, benefit information may pertain to, for example, cash back, a discount on a good or service, a complimentary good or service, etc. The enabling organization may be one (or more) of multiple enabling organizations. From a consumer, enabling organization information may be received (1720) pertaining to an enabling organization to which the consumer is affiliated. Consumer information may also be received from the consumer, including consumer identification information for identifying the consumer and consumer interest data for identifying at least one interest of the consumer. In an embodiment, the enabling organization information may be received from the enabling organization itself or from an administrator/operator of a benefits matching system/network to which the consumer is attached in order to perform the steps/actions in the method described. As described in detail above, the first affiliate and the consumer may be authenticated, typically individually (1730). In a memory of a computer system, the consumer information, enabling organization information, and benefit information may be stored along with other received information (1740). The consumer interest data, enabling organization information, and benefit information may be analyzed automatically (1750) in the computer system to determine whether any enabling organization to which the consumer is affiliated is offering a benefit for the consumer that is applicable to the consumer interest data.

A determination may be made (1760) regarding a suppression time window. While automatically being informed of benefits, e.g., benefit notification is “pushed” to the consumer, constant or repetitive reminders may become an irritant to the consumer. Therefore, the computer-implemented system and/or method may include a suppression time window such that, if selected, the consumer will not be reminded/informed/notified of a particular benefit more than a selectable number of times in the suppression time window. The suppression time window will have a selectable time duration that the consumer can change at his/her convenience. A determination may be made (1770) of a time duration from a time of a previous display of a benefit to the consumer, e.g., how long has it been since the consumer was reminded/informed/notified of the availability of the first benefit. In an embodiment, this time duration may be determined for a particular benefit from a particular enabling organization, and/or from a particular venue. In an embodiment, the consumer will be reminded/informed of a benefit available at a second venue even though the consumer was previously reminded/informed/notified within the suppression time window of availability of the same benefit at a first venue.

A message may be displayed (1780) to inform the consumer of information regarding the first benefit only if the time duration is greater than the suppression time window. The message may be received on a mobile device of the consumer, such as a hand-held device. In an embodiment, the benefit information may be displayed in a format indicating the source of the benefit information. In an embodiment, a duration of the suppression time window is selectable by the consumer. In an embodiment the consumer may control, either manually or by presetting an automatic setting, the display suppression time window such that the consumer's device displays notifications for a first selected amount of time and does not display notifications for a second selected amount of time, where the first and second selected amounts of time may be the same or different.

In an embodiment, a benefits matching system may include a computer processor that is accessible to members of an online community who each are authenticated as being entitled to access information pertaining to benefits offered by at least one of a plurality of enabling organizations. The benefits matching system may also include a memory operationally connected to the processor. The benefits matching system may also include a non-transient computer-readable storage medium comprising computer-executable instructions stored tangibly thereon, the instructions when executed causing the processor to perform the operations outlined above and in FIG. 17. In another embodiment, the computer-executable instructions of the benefits matching system may include a predetermined algorithm to determine a plurality of venues as discussed above.

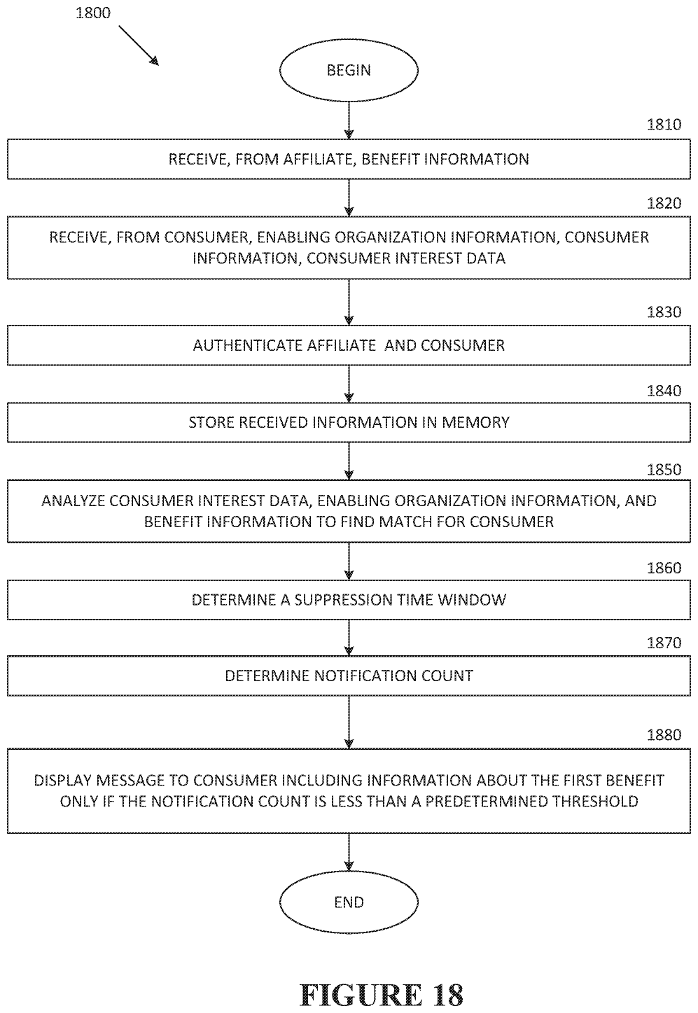

With reference to FIG. 18, a flow diagram in accordance with some embodiments is presented. After process 1800 begins, the method may include receiving (1810), from a first affiliate of an enabling organization, benefit information pertaining to at least one benefit that the affiliate knows is offered by the enabling organization. The enabling organization may be one (or more) of multiple enabling organizations. From a consumer, enabling organization information may be received (1820) pertaining to an enabling organization to which the consumer is affiliated. Consumer information may also be received from the consumer, including consumer identification information for identifying the consumer and consumer interest data for identifying at least one interest of the consumer. In an embodiment, the enabling organization information may be received from the enabling organization itself or from an administrator/operator of a benefits matching system/network to which the consumer is attached in order to perform the steps/actions in the method described. As described in detail above, the first affiliate and the consumer may be authenticated, typically individually (1830). In a memory of a computer system, the consumer information, enabling organization information, and benefit information may be stored along with other received information (1840). The consumer interest data, enabling organization information, and benefit information may be analyzed automatically (1850) in the computer system to determine whether any enabling organization to which the consumer is affiliated is offering a benefit for the consumer that is applicable to the consumer interest data.

A determination may be made (1860) regarding a suppression time window. While automatically being informed of benefits, e.g., benefit notification is “pushed” to the consumer, constant or repetitive reminders may become an irritant to the consumer. Therefore, the computer-implemented system and/or method may include a suppression time window such that, if selected, the consumer will not be reminded/informed/notified of a particular benefit more than a selectable number of times in the suppression time window. In an embodiment, the suppression time window will have a selectable time duration that the consumer can change at his/her convenience. In an embodiment, the number of notifications that the consumer may receive during the suppression time window is selectable by the consumer. A determination may be made (1870) of a notification count where the notification count represents the number of displays/notifications of a benefit the consumer has received within the suppression window. In an embodiment, this notification count may be determined for a particular benefit from a particular enabling organization, and/or from a particular venue. In an embodiment, the consumer will be reminded/informed/notified of a benefit available at a second venue even though the consumer was previously reminded within the suppression time window of availability of the same benefit at a first venue.

A message may be displayed (1880) to inform the consumer of information regarding the first benefit only if the notification count is less than (in an embodiment, less than or equal to) a predetermined threshold. The message may be received on a mobile device of the consumer, such as a hand-held device. In an embodiment, the benefit information may be displayed in a format indicating the source of the benefit information. In an embodiment, a duration of the suppression time window is selectable by the consumer. In an embodiment, the notification count threshold is selectable by the consumer. In an embodiment the consumer may control, either manually or by presetting an automatic setting, the notification count threshold such that the consumer's device displays notifications for a first selected notification count and does not display notifications for a second selected notification count, where the first and second selected notification amounts may be the same or different.

In an embodiment, a benefits matching system may include a computer processor that is accessible to members of an online community who each are authenticated as being entitled to access information pertaining to benefits offered by at least one of a plurality of enabling organizations. The benefits matching system may also include a memory operationally connected to the processor. The benefits matching system may also include a non-transient computer-readable storage medium comprising computer-executable instructions stored tangibly thereon, the instructions when executed causing the processor to perform the operations outlined above and in FIG. 18. In another embodiment, the computer-executable instructions of the benefits matching system may include a predetermined algorithm to determine a plurality of venues as discussed above.

Stacked Benefits

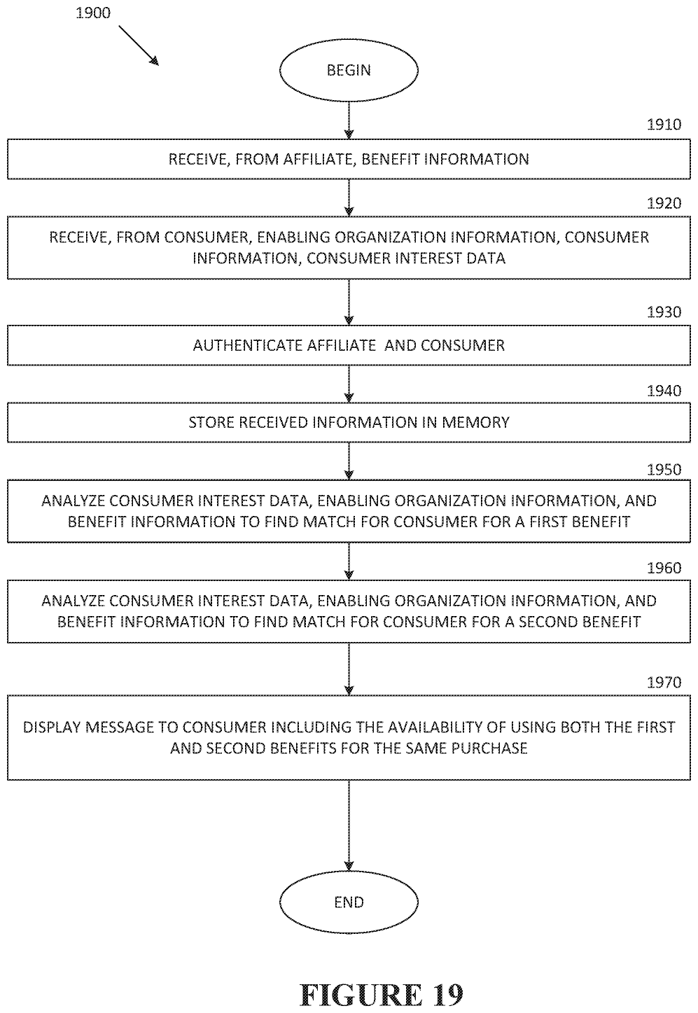

With reference to FIG. 19, a flow diagram in accordance with some embodiments is presented. After process 1900 begins, the method may include receiving (1910), from a first affiliate of an enabling organization, benefit information pertaining to at least one benefit that the affiliate knows is offered by the enabling organization. As stated above, benefit information may pertain to, for example, cash back, a discount on a good or service, a complimentary good or service, etc. The enabling organization may be one (or more) of multiple enabling organizations. From a consumer, enabling organization information may be received (1920) pertaining to an enabling organization to which the consumer is affiliated. Consumer information may also be received from the consumer, including consumer identification information for identifying the consumer and consumer interest data for identifying at least one interest of the consumer. In an embodiment, the enabling organization information may be received from the enabling organization itself or from an administrator/operator of a benefits matching system/network to which the consumer is attached in order to perform the steps/actions in the method described. As described in detail above, the first affiliate and the consumer may be authenticated, typically individually (1930). In a memory of a computer system, the consumer information, enabling organization information, and benefit information may be stored along with other received information (1940). The consumer interest data, enabling organization information, and benefit information may be analyzed automatically (1950) in the computer system to determine whether any enabling organization to which the consumer is affiliated is offering a first benefit for the consumer that is applicable to the consumer interest data. The consumer interest data, enabling organization information, and benefit information may be analyzed automatically (1960) in the computer system to determine whether any enabling organization to which the consumer is affiliated is offering a second benefit for the consumer that is applicable to the consumer interest data.

A message may be displayed (1970) to inform the consumer that the first and second benefits may both be used for the same purchase at a venue. In an embodiment, the consumer's device may display which of multiple benefits may be stacked at a particular venue. In an embodiment, the device may display icons for each benefit and show some relationship between those icons which can be stacked at a particular venue, e.g., a line connecting the icons, one icon at least partially overlapping another icon, etc.

In an embodiment, a benefits matching system may include a computer processor that is accessible to members of an online community who each are authenticated as being entitled to access information pertaining to benefits offered by at least one of a plurality of enabling organizations. The benefits matching system may also include a memory operationally connected to the processor. The benefits matching system may also include a non-transient computer-readable storage medium comprising computer-executable instructions stored tangibly thereon, the instructions when executed causing the processor to perform the operations outlined above and in FIG. 19. In another embodiment, the computer-executable instructions of the benefits matching system may include a predetermined algorithm to determine a plurality of venues as discussed above.

In an embodiment, the consumer interest data may include at least one filter configurable by the consumer. The filter may be one or more of: a particular benefit, a particular category of benefits, and/or a particular enabling organization. In an embodiment, the consumer information is received from a mobile device of the consumer, which may be a handheld device. In other embodiments, may include receiving auxiliary information of the first benefit which includes an expiration date of the first benefit or a link to a website for a description or for redemption instructions for the first benefit. In an embodiment, the auxiliary information is received from a second affiliate of the first enabling organization different from the first affiliate, wherein the second affiliate has an affiliation with the first enabling organization, the affiliation being a pre-existing relationship with the first enabling organization that enables the second affiliate to obtain at least one benefit from the first enabling organization not otherwise available to the second affiliate, and wherein the second affiliate is an authenticated member of the online community. In a further embodiment, the auxiliary information is received from a moderator of the online community including the first affiliate and the consumer. In still another embodiment, the auxiliary information is received from an automated agent configures to automatically provide information to assist members of the online community. In a still further embodiment, the benefit information is displayed in a format indicating the source of the benefit information. In yet another embodiment, the computer-implemented method for matching a consumer to available benefits includes the steps of receiving an input from the consumer indicative of the consumer's desire to avail himself or herself of the first and second benefits, and purchasing a good or service associated with the consumer interest data and applying the first and second benefits to the purchase of the good or service.

In yet further embodiments, a computer-implemented system and/or method for matching a consumer to multiple available benefits may automatically inform a consumer that two or more of the multiple available benefits can be used simultaneously (e.g., the benefits can be stacked) for a single purchase.

Benefits Along Planned Route

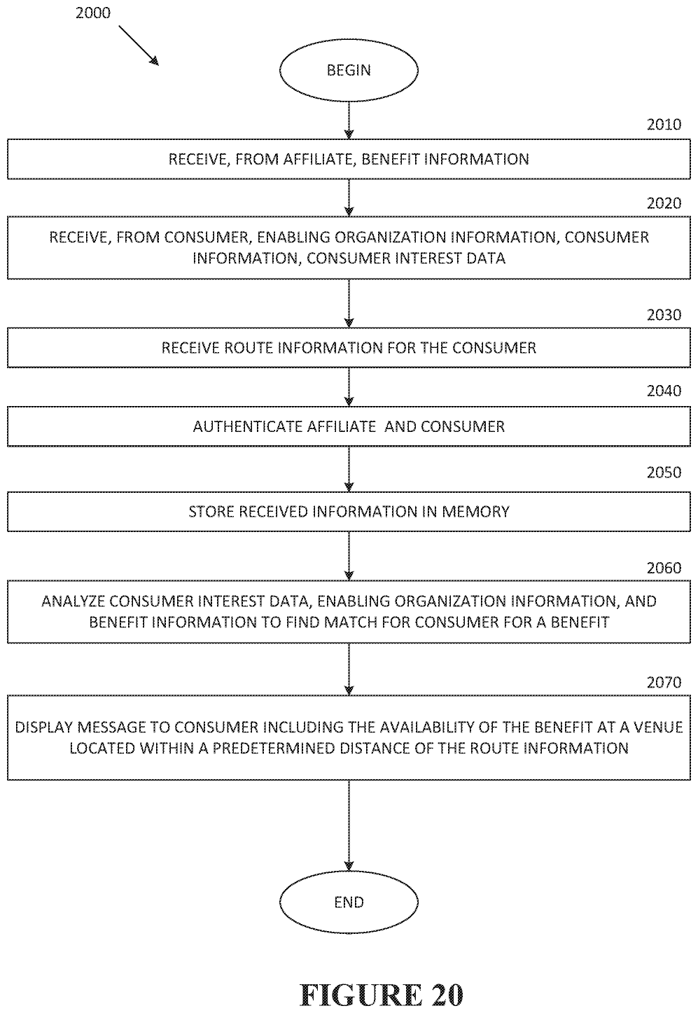

With reference to FIG. 20, a flow diagram in accordance with some embodiments is presented. After process 2000 begins, the method may include receiving (2010), from a first affiliate of an enabling organization, benefit information pertaining to at least one benefit that the affiliate knows is offered by the enabling organization. As stated above, benefit information may pertain to, for example, cash back, a discount on a good or service, a complimentary good or service, etc. The enabling organization may be one (or more) of multiple enabling organizations. From a consumer, enabling organization information may be received (2020) pertaining to an enabling organization to which the consumer is affiliated. Consumer information may also be received from the consumer, including consumer identification information for identifying the consumer and consumer interest data for identifying at least one interest of the consumer. In an embodiment, the enabling organization information may be received from the enabling organization itself or from an administrator/operator of a benefits matching system/network to which the consumer is attached in order to perform the steps/actions in the method described. Route information for the consumer to travel from a first location to a second location may be received (2030). In an embodiment, the route information may originate from a second, different, application and/or system, such as route information from a ride planning application/system. The route information may be used as an input to the computer-implemented benefits matching system to provide notification to the consumer of available benefits at venues that are located along (e.g., within a predetermined, selectable distance of) or at or near the terminus of the planned route. The benefit information may be pushed out to the consumer for viewing on a display that is connected to either the benefits system or the ride planning system.

As described in detail above, the first affiliate and the consumer may be authenticated, typically individually (2040). In a memory of a computer system, the consumer information, enabling organization information, and benefit information may be stored along with other received information (2050). The consumer interest data, enabling organization information, and benefit information may be analyzed automatically (2060) in the computer system to determine whether any enabling organization to which the consumer is affiliated is offering a benefit for the consumer that is applicable to the consumer interest data. A message may be displayed (2070) to inform the consumer of information regarding the availability of the benefit at a venue that is located within a first predetermined distance of the planned route.

In an embodiment, the ride planning system may be a taxi application/system, a radio car application/system, a ride hiring system, a Waze™ application/system, an Uber™ application/system, a Lyft™ application/system, a mapping application/system, or any other similar application/system that plans a travel route.

In an embodiment, the message displayed to the consumer is automatically displayed on a mobile device running an application for the computer-implemented method for matching a consumer to available benefits. In another embodiment, the message displayed to the consumer is displayed on the mobile device running an application program for the ride planning system. In a further embodiment, the message is automatically displayed to the consumer only when the consumer is within a second predetermined distance (selectable by the consumer) of the venue. As a non-limiting example, the message is displayed when the consumer is traveling along the planned route and approaches within 500 feet (or some other predetermined distance) of the venue until the consumer (traveling along the planned route or otherwise) departs further than 500 feet (or some other predetermined distance) from the venue. It is contemplated that the approach and departure distances do not have to be the same value. In a still further embodiment, the displaying of an available benefit while the consumer is traveling along a planned route may be used in conjunction with the time suppression window and/or the notification count embodiments described above.

In an embodiment, a benefits matching system may include a computer processor that is accessible to members of an online community who each are authenticated as being entitled to access information pertaining to benefits offered by at least one of a plurality of enabling organizations. The benefits matching system may also include a memory operationally connected to the processor. The benefits matching system may also include a non-transient computer-readable storage medium comprising computer-executable instructions stored tangibly thereon, the instructions when executed causing the processor to perform the operations outlined above and in FIG. 20. In another embodiment, the computer-executable instructions of the benefits matching system may include a predetermined algorithm to determine a plurality of venues as discussed above.

Although examples are illustrated and described herein, embodiments are nevertheless not limited to the details shown, since various modifications and structural changes may be made therein by those of ordinary skill within the scope and range of equivalents of the claims.

What is claimed is:

1. A computer-implemented method for matching a consumer to available benefits, the method comprising the steps of:
(a) receiving, from a first affiliate of a first enabling organization of a plurality of enabling organizations, first benefit information pertaining to a first benefit that said first affiliate knows is offered by said first enabling organization, wherein said first affiliate has an affiliation with said first enabling organization, said affiliation being a pre-existing relationship with said first enabling organization that enables said first affiliate to obtain at least one benefit from said first enabling organization not otherwise available to said first affiliate;
(b) receiving, from the first affiliate second benefit information pertaining to a second benefit that said first affiliate knows is offered by a second enabling organization of the plurality of enabling organizations, wherein said first affiliate has an affiliation with said second enabling organization, said affiliation being a pre-existing relationship with said second enabling organization that enables said first affiliate to obtain at least one benefit from said second enabling organization not otherwise available to said first affiliate;
(c) receiving, from a consumer, wherein said consumer is affiliated with said first enabling organization, and wherein said consumer is not affiliated with said second enabling organization:
(i) enabling organization information pertaining to said first enabling organization; and
(ii) consumer information including consumer identification information for identifying said consumer;
(d) receiving route information for said consumer to travel from a first location to a second location;
(e) authenticating, individually, said first affiliate and said consumer as each being a member of an online community who each are entitled to access information pertaining to benefits offered by one or more of said plurality of enabling organizations;
(f) storing in a memory of a computer system said enabling organization information, said consumer information, and said first and second benefit information, wherein said computer system is accessible to authenticated members of the online community and only affiliates of any of said plurality of enabling organizations, wherein said affiliates are members of said online community, and wherein only said members are capable of providing benefit information to said computer system;
(g) automatically linking said consumer with a set of benefits, wherein said set of benefits comprises said first benefit and said second benefit, and wherein said set of benefits is based at least in part on said enabling organization information;
(h) receiving search results generated by said search engine in response to receipt of consumer interest data submitted by said consumer through a computing device;
(i) analyzing said search results and automatically selecting a subset of benefits from said set of benefits based on the analyzed search results, wherein said subset of benefits comprises said first benefit and said second benefit;
(j) determining a venue applicable to said first benefit wherein said venue is within a first predetermined distance of said route information; and
(k) displaying to said consumer a message including said first benefit wherein the message includes said venue applicable to said first benefit.

2. The method of claim 1 wherein said route information is provided from a ride planning system.

3. The method of claim 2 wherein said ride planning system is selected from the group consisting of: an Uber application, a Lyft application, a Waze application, a taxi application, and combinations thereof.

4. The method of claim 1 wherein the message displayed to said consumer is automatically displayed on a mobile device running an application for the computer-implemented method for matching a consumer to available benefits.

5. The method of claim 2 wherein the message displayed to said consumer is displayed on the mobile device running an application for the ride planning system.

6. The method of claim 1 wherein the message displayed to said consumer is automatically displayed only when said consumer is within a second predetermined distance of the venue.

7. The method of claim 1 wherein said first predetermined distance is selectable by said consumer.

8. The method of claim 6 wherein said second predetermined distance is selectable by said consumer.

9. The method of claim 1 further comprising the steps of:
(l) determining a suppression time window;
(m) determining a time duration from a time of a previous display of said first benefit to said consumer; and
(n) displaying said message to said consumer only for the condition where the time duration is greater than the suppression time window.

10. The method of claim 1 further comprising the steps of:
(l) determining a suppression time window;
(m) determining a notification count, wherein the notification count represents the number of displays of said first benefit to said consumer within the suppression time window; and
(n) displaying said message to said consumer only for the condition where the notification count is less than a predetermined threshold.

11. A benefits matching system comprising:
a computer processor, wherein said computer processor is accessible to members of an online community who each are authenticated as being entitled to access information pertaining to benefits offered by at least one of a plurality of enabling organizations;
a memory operationally connected to said processor;
a search engine operationally connected to said processor; and
a non-transient computer-readable storage medium comprising computer-executable instructions stored tangibly thereon, said instructions when executed causing said processor to perform the operations of:
(a) receiving, from a first affiliate of a first enabling organization of a plurality of enabling organizations, first benefit information pertaining to a first benefit that said first affiliate knows is offered by said first enabling organization, wherein said first affiliate has an affiliation with said first enabling organization, said affiliation being a pre-existing relationship with said first enabling organization that enables said first affiliate to obtain at least one benefit from said first enabling organization not otherwise available to said first affiliate;
(b) receiving, from the first affiliate second benefit information pertaining to a second benefit that said first affiliate knows is offered by a second enabling organization of the plurality of enabling organizations, wherein said first affiliate has an affiliation with said second enabling organization, said affiliation being a pre-existing relationship with said second enabling organization that enables said first affiliate to obtain at least one benefit from said second enabling organization not otherwise available to said first affiliate;
(c) receiving, from a consumer, wherein said consumer is affiliated with said first enabling organization, and wherein said consumer is not affiliated with said second enabling organization:
(i) enabling organization information pertaining to said first enabling organization; and
(ii) consumer information including consumer identification information for identifying said consumer;
(d) receiving route information for said consumer to travel from a first location to a second location;
(e) authenticating, individually, said first affiliate and said consumer as each being a member of an online community who each are entitled to access information pertaining to benefits offered by one or more of said plurality of enabling organizations;
(f) storing in a memory of a computer system said enabling organization information, said consumer information, and said first and second benefit information, wherein said computer system is accessible to authenticated members of the online community and only affiliates of any of said plurality of enabling organizations, wherein said affiliates are members of said online community, and wherein only said members are capable of providing benefit information to said computer system;
(g) automatically linking said consumer with a set of benefits, wherein said set of benefits comprises said first benefit and said second benefit, and wherein said set of benefits is based at least in part on said enabling organization information;
(h) receiving search results generated by said search engine in response to receipt of consumer interest data submitted by said consumer through a computing device;
(i) analyzing said search results and automatically selecting a subset of benefits from said set of benefits based on the analyzed search results, wherein said subset of benefits comprises said first benefit and said second benefit;
(j) determining a venue applicable to said first benefit wherein said venue is within a first predetermined distance of said route information; and
(k) displaying to said consumer a message including said first benefit wherein the message includes said venue applicable to said first benefit.

12. The system of claim 11 wherein said route information is provided from a ride planning system.

13. The system of claim 12 wherein said ride planning system is selected from the group consisting of: an Uber application, a Lyft application, a Waze application, a taxi application, and combinations thereof.

14. The system of claim 11 wherein the message displayed to said consumer is automatically displayed on a mobile device running an application for the computer-implemented method for matching a consumer to available benefits.

15. The system of claim 12 wherein the message displayed to said consumer is displayed on the mobile device running an application for the ride planning system.

16. The system of claim 11 wherein the message displayed to said consumer is automatically displayed only when said consumer is within a second predetermined distance of the venue.

17. The system of claim 11 wherein said first predetermined distance is selectable by said consumer.

18. The system of claim 16 wherein said second predetermined distance is selectable by said consumer.

19. The system of claim 11 wherein said instructions when executed further cause said processor to perform the operations of:
(l) determining a suppression time window;
(m) determining a time duration from a time of a previous display of said first benefit to said consumer; and
(n) displaying said message to said consumer only for the condition where the time duration is greater than the suppression time window.

20. The system of claim 11 wherein said instructions when executed further cause said processor to perform the operations of:
(l) determining a suppression time window;
(m) determining a notification count, wherein the notification count represents the number of displays of said first benefit to said consumer within the suppression time window; and
(n) displaying said message to said consumer only for the condition where the notification count is less than a predetermined threshold.
